(19) United States
(12) Patent Application Publication
(10) Pub. No.: US 2023/0368084 A1
(43) Pub. Date: Nov. 16, 2023

(54) SPLIT STAYS RANKING AND MATCHING

(71) Applicant: Airbnb, Inc., San Francisco, CA (US)

(72) Inventors: Xiaoxin Yin, San Jose, CA (US); Dillon Davis, San Francisco, CA (US); Mihajlo Grbovic, Moss Beach, CA (US); Aditya Mukherji, San Francisco, CA (US); Kedar Bellare, San Jose, CA (US); FNU Dishant, Fremont, CA (US); Karen Ouyang, San Francisco, CA (US); Soumyadip Banerjee, Burlingame, CA (US); Min Liu, San Francisco, CA (US); Pauline Nguyen, Columbia Falls, MT (US); Elizabeth Han Lin, San Francisco, CA (US); Walker John Alexander Henderson, Philadelphia, PA (US); Dang Quang Tran, New York, NY (US); Caroline Leung, Moraga, CA (US); Liwei He, Bellevue, WA (US); Chen Qian, Mountain View, CA (US); Ying Xiao; Xiaotang Wang, San Francisco, CA (US)

(21) Appl. No.: 18/136,674

(22) Filed: Apr. 19, 2023

Related U.S. Application Data
(60) Provisional application No. 63/340,163, filed on May 10, 2022.

(51) Int. Cl. G06Q 10/02; G06Q 30/0645; G06Q 30/04

(52) U.S. Cl. CPC G06Q 10/025; G06Q 30/0645; G06Q 30/04

(57) ABSTRACT

A search system that receives and returns results for split stays is described. The search system receives, from a searching end-user, a listing request specifying a multiple-day length of stay parameter. The search system determines that the multiple-day length of stay parameter of the listing request transgresses a minimum length of stay threshold and, in response, generates a combined listing that includes a first listing of the plurality of listings associated with a first portion of the multiple-day length of stay parameter and a second listing of the plurality of listings associated with a second portion of the multiple-day length of stay parameter. The combined listing is presented with one or more other listings of the plurality of listings that match the listing request in a ranked order.

### RELATED APPLICATION

This application claims the priority benefit of U.S. Provisional Application No. 63/340,163, filed on May 10, 2022, which is hereby incorporated by reference in its entirety.

### TECHNICAL FIELD

The present disclosure generally relates to special-purpose machines that manage data processing and improvements to such variants, and to the technologies by which such special-purpose machines become improved compared to other special-purpose machines for generating split stay searches.

### BACKGROUND

Network site users can create content for viewing and interaction by other network site users (e.g., booking, registering, subscribing, viewing of listings). The posted content can be updated, created, or deleted, and it can be computationally challenging for a network site to return valid search results to network site users searching for content with specified parameters (e.g., dates, categories, prices, quantity). For example, if there are a large number of users posting and updating content and also a large number of users submitting complex searches for the posted content, any delay in computation due to query complexity may cause inaccurate results to be returned and cause large computational resource consumption (e.g., processing, memory, network overhead).

### BRIEF DESCRIPTION OF THE DRAWINGS

Various ones of the appended drawings merely illustrate example embodiments of the present disclosure and should not be considered as limiting its scope.

FIG. 1 is a block diagram illustrating a combined listing search system implemented in a networked environment, according to some example embodiments.

FIG. 2 shows an example of functional engines of a combined listing search system, according to some example embodiments.

FIG. 3 shows a listings network site user interface generated by the listing network platform and combined listing search system, according to some example embodiments.

FIG. 4 illustrates an example user interface for a description of a listing for a rental item, according to some example embodiments.

FIGS. 5-7 show example configurations of a combined listings search system user interface, according to some example embodiments.

FIG. 8 shows a diagram for combined listing searches, according to some example embodiments.

FIGS. 9A-9C show flow diagrams of various processes for displaying listings, according to some example embodiments.

FIG. 10 is a block diagram illustrating the architecture of software used to implement the user messaging system, according to some example embodiments.

FIG. 11 shows a machine as an example computer system with instructions to cause the machine to implement the user message system, according to some example embodiments.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

As discussed above, it can be difficult to return up-to-date results for complex queries for content posted on a network site. To this end, a split stay listings search system can be configured to efficiently search for complex queries and return accurate results with low computational resource usage. Although in the following discussion the example posted content are accommodation listings posted on a network site for searching and interaction with other end-users, it is appreciated that other types of network site content posted by end-users and searched for by other end-users can likewise be implemented in the split stay search process, such as transportation, experiences, and events.

Generally, a listing platform can be searched for result listings that are available for a specified date range, price range, and/or other attributes (amenities, cancelation policy, etc.), which can be specified in a given query (e.g., text field, drop-down menu, checkbox filters). While some of the listing attributes are relatively static and common across the potential results and therefore fast to look up, pricing and date availability are highly dynamic because (1) pricing and date availability change frequently (e.g., the host of a listing updates an availability calendar, dynamic pricing changes due to demand and supply), and (2) the price and date availability attributes have a higher accuracy burden (e.g., searching end-users have a low tolerance for pricing discrepancies). To address these issues, price and date availability attributes are handled at search time in response to handling each new query. This can consume a significant amount of computational resources. For example, the process of computing pricing and availability per listing can consume over 30% of search-serving CPU processing for regular queries (e.g., simple date range, finite price range, small geographic area).

These inefficiencies can drastically increase by orders of magnitude for complex queries, such as a listings query with multiple possible date ranges, which may be a simple demand for an end-user (e.g., users may not know at search time when they have availability or time off for travel). For example, a micro-flexible (“microflex”) query in which the end-user searches for listings in a geographic area (e.g., San Francisco) for June 13-15, +/−7 days, resolves to up to (7*2+1)\hat{ }2=225 date combinations. In a given search, over 30% of search-serving CPU processes is spent on computing pricing and availability for just one date range. As such, it can be computationally impractical to compute pricing and availability for up to 225 date ranges in a timely manner for the searching end-user.

Sometimes, these systems can use up the computational resources to find matching listings and may end up failing to identify sufficient number of candidate matches. The results presented to the user can therefore be minimal, which cause the user to manually adjust search parameters in an attempt to find better matches. The revision of the search parameters causes the systems to again consume a great deal of computational resources to find match results. In many cases, users may still be unsatisfied with the matches that are returned and may decide to manually shorten or extend the duration of stay. Such repetitive and manual processes are incredibly time consuming and can be very frustrating to end users. This can result in missed opportunities and wasted computational resources.

To address these technical problems, the disclosed techniques provide a network site that automatically, seamlessly and intelligently combines different individual listings into a single combined listing that matches a given search request. The single combined listing can be presented together with other combined listings and/or individual listings to satisfy a query. By generating a combined listing from the available listings and presenting that combined listing as one of the candidate search results, the diversity and variety of available matching listings for a given query is improved. Namely, by adding more variety in the results presented to a searching end-user, the likelihood of the user completing a transaction and avoiding requesting additional searches to be performed is reduced. This, in effect, reduces the amount of computational resources needed to be dedicated and consumed by a given searching end-user, which frees up such resources for other tasks and satisfying other search requests.

In some examples, the disclosed techniques receive, from a searching end-user, a listing request for one or more of the listings posted to the network site, the listing request specifying a multiple-day length of stay parameter. The disclosed techniques determine that the multiple-day length of stay parameter of the listing request transgresses a minimum length of stay threshold, such as a five day minimum. In response, the disclosed techniques generate a combined listing that includes a first listing of the plurality of listings associated with a first portion of the multiple-day length of stay parameter and a second listing of the plurality of listings associated with a second portion of the multiple-day length of stay parameter. For example, the combined listing can include a first listing for satisfying the first five days (e.g., days 1-5) of a ten day stay or trip and a second listing for satisfying the last five days (e.g., days 6-10) of the ten day stay or trip. The disclosed techniques cause, on a user device of the searching end-user, presentation of the combined listing together with one or more other listings of the plurality of listings that match the listing request in a ranked order.

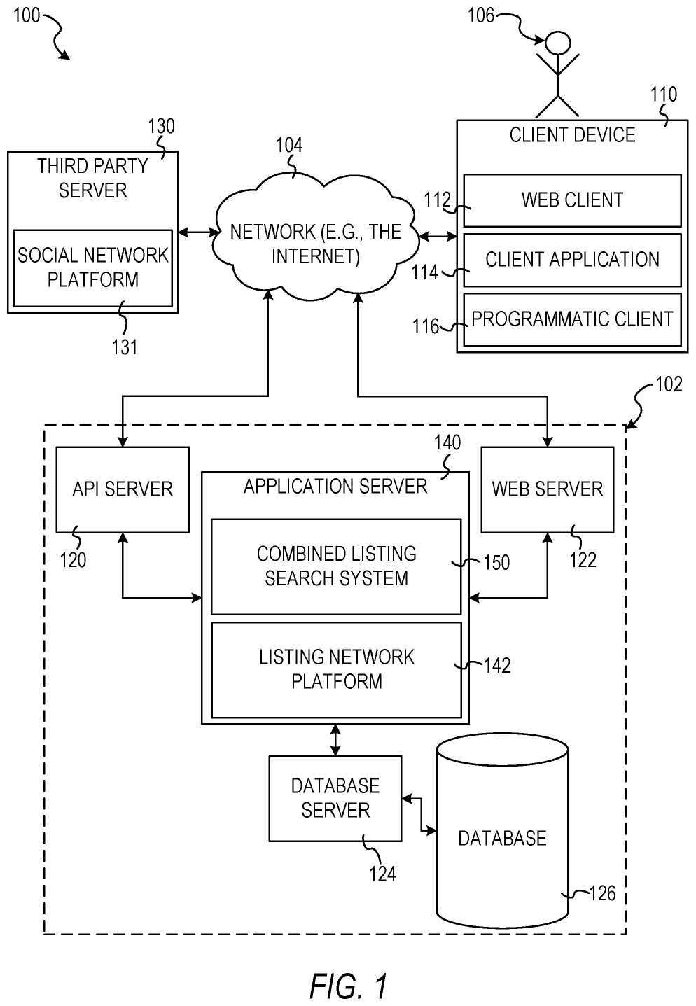

With reference to FIG. 1, an example embodiment of a high-level client-server-based network architecture 100 is shown. A networked system 102, in the example form of a network-based marketplace or payment system, provides server-side functionality via a network 104 (e.g., the Internet or wide area network (WAN)) to one or more client devices 110. In some implementations, a user (e.g., user 106) interacts with the networked system 102 using the client device 110.

FIG. 1 illustrates, for example, a web client 112 (e.g., a browser), client application(s) 114, and a programmatic client 116 executing on the client device 110. The client device 110 includes the web client 112, the client application(s) 114, and the programmatic client 116 alone, together, or in any suitable combination. Although FIG. 1 shows one client device 110, in other implementations, the network architecture 100 comprises multiple client devices.

In various implementations, the client device 110 comprises a computing device that includes at least a display and communication capabilities that provide access to the networked system 102 via the network 104. The client device 110 comprises, but is not limited to, a remote device, work station, computer, general purpose computer, Internet appliance, hand-held device, wireless device, portable device, wearable computer, cellular or mobile phone, Personal Digital Assistant (PDA), smart phone, tablet, ultrabook, netbook, laptop, desktop, multi-processor system, microprocessor-based or programmable consumer electronic, game consoles, set-top box (STB), network personal computer (PC), mini-computer, and so forth. In an example embodiment, the client device 110 comprises one or more of a touch screen, accelerometer, gyroscope, biometric sensor, camera, microphone, Global Positioning System (GPS) device, and the like.

The client device 110 communicates with the network 104 via a wired or wireless connection. For example, one or more portions of the network 104 comprises an ad hoc network, an intranet, an extranet, a Virtual Private Network (VPN), a Local Area Network (LAN), a wireless LAN (WLAN), a WAN, a wireless WAN (WWAN), a Metropolitan Area Network (MAN), a portion of the Internet, a portion of the Public Switched Telephone Network (PSTN), a cellular telephone network, a wireless network, a Wireless Fidelity (WI-FI®) network, a Worldwide Interoperability for Microwave Access (WiMax) network, another type of network, or any suitable combination thereof.

In some example embodiments, the client device 110 includes one or more of the applications (also referred to as “apps”) such as, but not limited to, web browsers, book reader apps (operable to read e-books), media apps (operable to present various media forms including audio and video), fitness apps, biometric monitoring apps, messaging apps, electronic mail (email) apps, e-commerce site apps (also referred to as “marketplace apps”), and reservation applications for temporary stays or experiences at hotels, motels, or residences managed by other end-users (e.g., a posting end-user who owns a home and rents out the entire home or private room). In some implementations, the client application(s) 114 include various components operable to present information to the user and communicate with networked system 102. In some embodiments, if the e-commerce site application is included in the client device 110, then this application is configured to locally provide the user interface and at least some of the functionalities with the application configured to communicate with the networked system 102, on an as-needed basis, for data or processing capabilities not locally available (e.g., access to a database of items available for sale, to authenticate a user, to verify a method of payment). Conversely, if the e-commerce site application is not included in the client device 110, the client device 110 can use its web browser to access the e-commerce site (or a variant thereof) hosted on the networked system 102.

The web client 112 accesses the various systems of the networked system 102 via the web interface supported by a web server 122. Similarly, the programmatic client 116 and client application(s) 114 accesses the various services and functions provided by the networked system 102 via the programmatic interface provided by an Application Program Interface (API) server 120.

Users (e.g., the user 106) comprise a person, a machine, or other means of interacting with the client device 110. In some example embodiments, the user 106 is not part of the network architecture 100, but interacts with the network architecture 100 via the client device 110 or another means. For instance, the user 106 provides input (e.g., touch screen input or alphanumeric input) to the client device 110 and the input is communicated to the networked system 102 via the network 104. In this instance, the networked system 102, in response to receiving the input from the user 106, communicates information to the client device 110 via the network 104 to be presented to the user 106. In this way, the user 106 can interact with the networked system 102 using the client device 110.

The API server 120 and the web server 122 are coupled to, and provide programmatic and web interfaces respectively to, one or more application server(s) 140. The application server(s) 140 may host a listing network platform 142 and a combined listing search system 150, each of which comprises one or more modules or applications and each of which can be embodied as hardware, software, firmware, or any combination thereof. The application server(s) 140 are, in turn, shown to be coupled to one or more database server(s) 124 that facilitate access to one or more information storage repositories or database(s) 126. In an example embodiment, the database(s) 126 are storage devices that store information to be posted (e.g., inventory, image data, catalog data) to the listing network platform 142. The database(s) 126 also stores digital goods information in accordance with some example embodiments.

Additionally, a social network platform 131 is illustrated as executing on third-party server(s) 130. Further, the social network platform 131 can programmatically access the networked system 102 via the programmatic interface provided by the API server 120. The social network platform 131 may comprise a social network website, messaging platform, and one or more APIs. In some example embodiments, the electronic message discussed below is a message sent to a given user via the social network platform 131 messaging system (e.g., social media chat message, post, ping (a “hello” notification), and so on).

The listing network platform 142 provides a number of publication functions and listing services to the users who access the networked system 102. While the listing network platform 142 is shown in FIG. 1 to form part of the networked system 102, it will be appreciated that, in alternative embodiments, the listing network platform 142 may form part of a web service that is separate and distinct from the networked system 102. In some implementations, the combined listing search system 150 provides functionality to recommend or generate one or more combined listings that include one or more individual listings as part of a single offering, as discussed in further detail below.

As referred to herein, the phase “combined listing” refers to a listing that is generated and presented to an end user which encapsulates or includes two or more other individual listings. An individual listing represents a single accommodation or experience that is separately and independently selectable by an end user to reserve a stay or consume. A combined listing represents multiple accommodations or experiences that are not separately and independently selectable to be consumed but are consumed together as part of the same accommodation on different dates or days to fulfill an entire length or duration of a requested accommodation. A part of the requested accommodation (e.g., the first five days) is consumed by a first of the multiple listings of the combined listing and another part of the requested accommodation (e.g., the last five days) is consumed by a second of the multiple listings of the combined listing. Namely, selecting a combined listing causes the multiple listings associated with or represented by the combined listing to be automatically reserved for consumption by an end user as part of fulfilling an entire stay.

While the client-server-based network architecture 100 shown in FIG. 1 employs a client-server architecture, the present inventive subject matter is not limited to such an architecture, and can equally be implemented in a distributed, or peer-to-peer, architecture system, for example. The various systems of the applications server(s) 140 (e.g., the listing network platform 142 and combined listing search system 150) may also be implemented as standalone software programs, which do not necessarily have networking capabilities.

The listing network platform 142 can be hosted on dedicated or shared server machines that are communicatively coupled to enable communications between server machines. The components themselves are communicatively coupled (e.g., via appropriate interfaces) to each other and to various data sources, so as to allow information to be passed between the applications or so as to allow the applications to share and access common data. Furthermore, the components access one or more database(s) 126 via the database server(s) 124. The listing network platform 142 provides a number of publishing and listing mechanisms whereby a seller (also referred to as a “first user,” posting user, host) may list (or publish information concerning) goods or services for sale or barter, a buyer (also referred to as a “second user,” searching user, guest) can express interest in or indicate a desire to purchase or barter such goods or services, and a transaction (such as a trade) may be completed pertaining to the goods or services. The listing network platform 142 allows the sellers or publishing users to specify whether their respective listing can or cannot be combined with other listings to form a combined listing. In some examples, the combined listing can only be generated using listings for which the sellers or publishing users approved having combined.

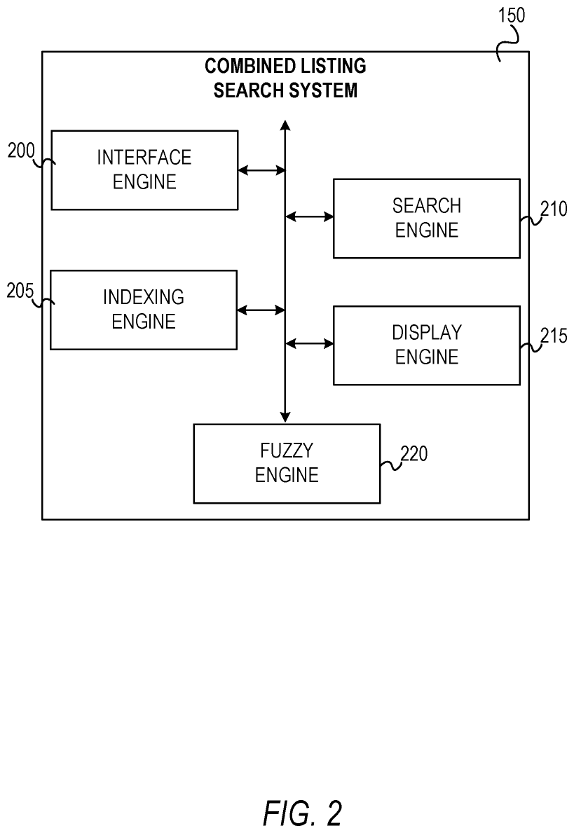

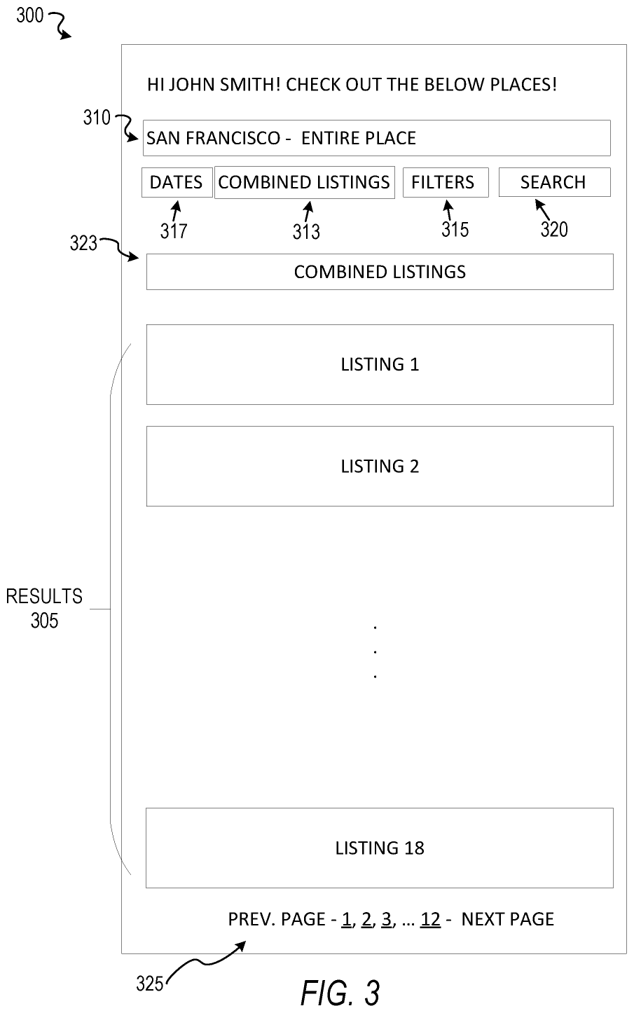

FIG. 2 shows example functional engines of the combined listing search system 150, according to some example embodiments. As illustrated, the combined listing search system 150 includes an interface engine 200 to generate the user interface content (e.g., FIGS. 3-7), an indexing engine 205 to index data to be searched and generate one or more combined listings, a search engine 210 to search, rank, and return results, and a display engine 215 to display updated results (e.g., in different locations).

The interface engine 200 manages generating user interface elements and processing user interactions with the user interface content. The indexing engine 205 manages indexing data to be searched (e.g., via the search engine 210). In some example embodiments, the indexing engine 205 comprises a mapping module (e.g., to read offline data such as signals that are read from Hive tables and computed daily) and a reducing module (e.g., to receive updates per listing ID, compute an updated event, and send the updated data to the search engine 210).

The search engine 210 manages searching, ranking, and returning listing results. In some examples, the search engine 210 comprises a root node search system that manages search request augmentation (e.g., getting user personalization data), aggregating results from different shards, and performing second pass ranking. Further, in some examples, the search engine 210 comprises a leaf node serving system that contains an inverted index (e.g., Apache Lucene) and can perform first pass ranking for different shards.

In some examples, the interface engine 200 receives, from a searching end-user, a listing request for one or more of the listings posted to the network site, the listing request specifying a multiple-day length of stay parameter. For example, the interface engine 200 receives input from an end user specifying a specific duration of stay or a minimum duration of stay (e.g., one week or one month) and/or a date range. The input can also include one or more other search criteria, such as location, destination category, type of accommodation, price range, size of the accommodation, and so forth.

The interface engine 200 provides the listing request to the search engine 210. The search engine 210 determines whether the multiple-day length of stay parameter of the listing request transgresses a minimum length of stay threshold. For example, the search engine 210 obtains a minimum length of stay threshold, which can be user specific or learned by a trained machine learning model (e.g., a neural network). In some examples, the minimum length of stay threshold is set to five days. The search engine 210 compares the multiple-day length of stay parameter of the listing request to the minimum length of stay threshold. In response to determining that the multiple-day length of stay parameter of the listing request exceeds the minimum length of stay threshold, the search engine 210 initiates a process to obtain and/or generate one or more combined listings. Otherwise, the search engine 210 continues a process of searching for individual listings that meet parameters of the listing request.

### Listing Categorization

In some examples, the indexing engine 205 processes individual listings to assign automatically and/or manually destination categories and/or criteria to each individual listing. The indexing engine 205 can use various data points and structured data about the individual listings and their geographical surroundings to associate one or more destination categories to each individual listing. In some cases, one listing can be associated with multiple destination categories or categories in general.

In some examples, the indexing engine 205 obtains data from hosts of the individual listings when the listings are created and from guests or users who booked stays at the individual listings. Using this data, the indexing engine 205 can associate the categories with the listings. In some cases, the indexing engine 205 uses data from nearby listings to the target listing (e.g., listings that are within a threshold distance of a target listing) to determine a category for the target listing, such as if insufficient amount of data is available for the target listing. For example, if a threshold quantity of nearby listing is associated with a particular destination category, the indexing engine 205 can increase a weight of a set of signals indicative that the target listing is also associated with the particular destination category.

In some examples, the host provided data can include a listing title, description or other structured data and the guest provided data includes reviews, direct responses to questions, and so forth. Keywords from the host provided data and the guest provided data are collected into the set of signals associated with the individual listing. In some examples, the indexing engine 205 can access activities that are generally performed within a threshold distance of the individual listing and add those activities into the set of signals associated with the individual listing. For example, if surfing experiences are conducted within a threshold distance of the individual listing, the indexing engine 205 can add surfing experiences to the set of signals with a specified weight. In some examples, the indexing engine 205 can access various geographical data sources, satellite data, government or city data and/or specialized open source data (e.g., a database of certain activities, such as surfing spots and their corresponding locations) over the Internet. These additional data sources can be used to determine if the individual listing is close to a coastline, certain beach or certain surfing spot or certain spot associated with activities.

In some examples, the indexing engine 205 processes the set of signals associated with the individual listing (e.g., the target listing) to assign one or more categories to the listing. In some examples, the indexing engine 205 can apply one or more machine learning models (e.g., machine learning models discussed below) to process images of the individual listings to extract probabilities of certain photographs containing certain geographical elements (e.g., a beach, lake, river, mountain, forest, and so forth). The indexing engine 205 can use the probabilities of the geographical elements contained in the photographs to assign the categories to the listings.

In some examples, the set of signals are processed by a machine learning model and/or using various heuristics to assign categories to the individual listings. In some examples, a machine learning model can be applied to the listings to assign a quality to the listings, such as based on listing attributes and/or photographs associated with the listings.

Each category assigned to the individual listings is also assigned a confidence score between 1-4 (e.g., a most confident, very confident, confident, and not confident score). The indexing engine 205 can identify a set of listings that are associated with a highest category confidence score and a highest quality score. The set of listings can be presented to an operator for manual review and to remove falsely tagged listings. In some cases, the indexing engine 205 can identify a second set of listings that are associated with a medium or low category confidence score and a highest or medium or low quality score. The second set of listings can be presented to an operator for manual review and to remove falsely tagged listings.

In some examples, the indexing engine 205 performs a process to algorithmically and/or using machine learning models tag or associate listings with categories and generate category scores. In some cases, the categories in which the listings are tagged can include a Near a beach category, a Beachfront category, a Lake house category, a Lakefront category, a Surfing category, a Golfing category, a Skiing category, a Countryside category, a Tropical category, an Arctic category, a Vineyards category, an Iconic Cities category, a Shared Home, a Near National Park category, a Near a Historic Site category, a Near a Theme Park category, and/or a Snorkeling category. Any other additional categories or alternative categories can be provided and used.

The indexing engine 205 can apply a machine learning model and/or process to select a cover image for each listing in association with a certain category. For example, a given listing can be in two different categories and can have different cover or front page images presented depending on which category is currently being presented to an end user. Namely, the given listing can be associated with a first cover image that is included in the given listing for a first category (e.g., countryside category) and can be associated with a second cover image that is included in the given listing for a second category (e.g., lake home category). When the countryside category is selected for presentation to the user, the given listing can be presented with the first cover image and when the lake home category is selected presentation to the user, the given listing can be presented with the second cover image.

To select the cover image for a given category, indexing engine 205 can access guidelines or rules for the given category that specify image attributes of the cover image. For example, the Beachfront category can specify image guidelines specifying that the photograph needs to depict a beach and body of water from the perspective of the property on the listing (e.g., from the deck/patio or the shoreline). As an alternative, the beach can be viewed from inside the property looking out the window. The indexing engine 205 can apply a machine learning model to images of a given listing to classify objects depicted in the image. If the classified objects correspond to the attributes of the image guidelines of the given category (e.g., the classified objects include a deck and a beach), the image is selected as the cover image for the listing for the given category.

In some examples, the indexing engine 205 selects the cover image or train the machine learning model to select a cover image by processing a collection of training images and features. Specifically, the training images can be formed by manually identifying images that are engaging and attractive listing photographs that align with each selected category. An exterior photograph is preferred over interior photographs and if there is no good exterior photograph, then an interior photograph is selected. The ideal photograph is one that shows the dwelling within the category, such as surrounding nature. The ideal photograph excludes annotated photographs with text, icons, or arrows, excludes people are blurry or crooked. Once a collection of cover images are manually selected for each category, the machine learning model can be applied to the collection of images to extract features of the images. The features are then associated with the category of the images. Then the indexing engine 205 applies the machine learning model to a new set of images of a listing, extracts the features of the new set of images, and selects one of the set of images for each category, as the cover image to use for the listing, based on matching the extracted features to the features associated with the category.

In some examples, the indexing engine 205 performs a process to algorithmically and/or using machine learning models rank the listings that are presented in each category.

In some examples, the indexing engine 205 collects various signals for each individual listing from one or more data sources. For example, the indexing engine 205 accesses host provided data (e.g., listing location, listing title and description to use to extract keywords to search category keywords), listing amenities and structure data (e.g., data indicating if it is an entire home, private room, presence or absence of a pool, shared or private, kitchen, private entrance, and so forth), and listing property type, such as whether the listing is an apartment, house, tent, airstream, and so forth. The indexing engine 205 can also access guest provided data including review text (which can be used to search category keywords), review ratings, review structured data answers (e.g., when the guest is asked after staying if the listing had the attributes that are specified in the individual listing). The indexing engine 205 can access other external environment information including data, such as locations of experiences that are relevant to certain categories (e.g., locations of all surfing experiences to be used for surfing collection, skiing experiences for ski collection, golf experiences for golf collection, etc.). The indexing engine 205 can access image related data to generate image quality estimations and to apply machine learning room type predictions. Namely, the indexing engine 205 can apply a machine learning classifier to predict whether each image of the listing is or includes a bedroom image, living room image, kitchen image, pool image, backyard image, water view image, and so forth. These data can be used to select an image to use as a cover image for the listing and/or to determine whether the listing is associated or matches certain guidelines of a category. The indexing engine 205 can access external environment information, such as places of interest data, such as locations of points of interest (POIs) that are relevant for certain categories. The indexing engine 205 can access external environment information such as satellite data to assign automatically listing attributes to each listing, such as to indicate if the listing is in the mountains, forest, near a lake, river, or coast. The indexing engine 205 can access various other external environment information such as geographical data to automatically determine if a listing is located in a rural, suburban, urban or metropolitan area or is in a tropical or arctic area and/or the listing climate.

In some examples, the indexing engine 205 generates a set of relevant keywords and translations for each category. For example, the indexing engine 205 specifies guidelines for each category, such as a Beachfront category includes listings that are 0.3 miles from a coast or a Skiing category includes listings that are less than 1 mile from a ski lift. The indexing engine 205 can process data of each listing to determine whether the listing satisfies the guidelines for a given category or set of categories and to determine if the keywords extracted from the listing match one or more of the category keywords. In such cases, the indexing engine 205 generates a score for the listing based on how well the listing matches the guidelines and based on the quantity of keywords that match the category keywords.

The indexing engine 205 can determine which of the signals obtained from the data sources for each listing are useful for certain categories. Namely, the indexing engine 205 can associate certain weights for the signals or portions of the signals with certain categories. Namely, the indexing engine 205 can associate a first set of signals of a given listing with respective first set of weights for a first category and can associate a second set of signals or the same first set of signals of the given listing with respective second set of weights for a second category. For example, for the Surfing category, the indexing engine 205 can use the following signals or can assign a maximum weight to the following signals: distance to known surfing POI (e.g., beach), distance to the coast, number of surfing keywords in the listing title, description and reviews, number of surfing experiences nearby the listing location, whether the listing is located in a rural or metropolitan area, whether water views are present in the listing photographs (as determined by the machine learning classifier).

Based on the weights and how well each listing correlates with the corresponding category guidelines and keywords, the indexing engine 205 can compute a category confidence score for each category. Namely, the indexing engine 205 can assign for each listing the category confidence score indicating how well the listing matches with each category or if the listing fails to match a given category. In some examples, linear regression is used to produce weights or weight values for each signal that is determined to be relevant to the category.

In some examples, the indexing engine 205 utilizes photograph quality to assign a rank to each listing in a given category. The photograph quality is determined algorithmically, manually, and/or using a machine learning model. The photograph quality can be selected from several scores including a most inspiring score, a high score, an acceptable score, a low quality score and an unacceptable score. In some examples, if a given category is selected, the indexing engine 205 causes the listings having photograph associated with the most inspiring score to be presented first, followed by the high score photographs, then acceptable photographs, and then low quality photographs.

In some examples, the most inspiring score represents a photograph that is similar to photographs associated with a luxurious category or in an architectural or design magazine. This quality can be a quality that a top tier photographer would achieve in terms of composition and attractiveness and of the listing, grounds and setting. The most inspiring score can cause the listing or photograph to stand out uniquely within the category. Attributes of the photograph that can be considered by the indexing engine 205 to assign the most inspiring score include a lack of blur, showing off the category, well maintained exterior but not necessarily a professional photograph, well-composed photograph, social media worthy, exceptionally unique and is the best of the best.

In some examples, the high score represents a photograph that is better than average composition, exposure and colors. The photograph validates and highlights the listing and the category. Attributes of the photograph that can be considered by the indexing engine 205 to assign the high score include a lack of blur, showing off the category, well maintained exterior but not necessarily a professional photograph, well-composed photograph, and social media worthy.

In some examples, the acceptable score represents a photograph that adequately reflects the target listing category but is not necessarily a professional photograph. Specifically, with such a score, the property listing exterior features are well maintained but not likely a listing that would be featured to introduce the collection to the public. Attributes of the photograph that can be considered by the indexing engine 205 to assign the acceptable score include a lack of blur, somewhat showing off the category, and well maintained exterior but not necessarily a professional photograph.

In some examples, the low score represents a photograph that is leaning towards unacceptable and where the listing is not particularly inspiring or attractive but meets minimum qualifications for the category. In another example, the low score represents a listing of higher quality that includes images where the photograph exposure, composition, and colors are lower than the average quality or the listing's exterior or yard is not well-maintained. Attributes of the photograph that can be considered by the indexing engine 205 to assign the acceptable score can include a lack of blur.

The unacceptable category can be assigned for photographs in which the composition, exposure, and alignment are poor in quality or the listing is unattractive. Also, photographs with this score fail to show off the category for non-proximity based categories.

In some examples, the indexing engine 205 automatically assigns a listing quality score to each listing in each category to rank the listings in the category. To do so, the indexing engine 205 can apply a machine learning model to listing quality signals to predict a quality estimation or rank for the listing. For example, the indexing engine 205 obtains or collects listing quality signals including: number of wishlists (normalized based on listing location and its age) indicting how many other users have added the listing to their wishlist, number of reviews and review ratings, number of impressions indicating how many people interacted with the listing, number of bookings, image quality scores produced by machine learning vision models, structured data guest responses, such as indicating if the listing decor is impressive, indicating if the place is stylish, and so forth, listing property type, listing tier, listing price, if the listing has professional photography, number of photographs, presence of quality keywords in the guest listings, and so forth.

The indexing engine 205 can generate training data that includes multiple listings and their corresponding listing quality signals. The training data can associate ground truth quality estimations (which can be machine generated or human specified). The indexing engine 205 can apply a machine learning model to the training data to generate a prediction of the quality estimation (e.g., indicating if the listings is a most inspiring tier, high tier, acceptable tier, or low quality). The output of the machine learning model can be compared with the ground truth quality estimation of each listing to compute a deviation and to update parameters of the machine learning model. This is the process (similar to what is discussed below) for training the machine learning model to estimate listing quality for new listings. The trained machine learning model can obtain listing quality signals for a new listing and can predict a listing quality estimation for the listing. In some cases, the listings that are associated with relatively high or relatively low quality estimations can be prioritized and selected for human review.

In some cases, the indexing engine 205 associates categories with certain groups of themes. Namely, the indexing engine 205 groups the categories by theme or group so that a first collection of categories is associated with a first group or theme and a second collection of categories is associated with a second group of theme. In some cases, a given category is associated with multiple groups of themes.

### Combined Listing Generation

The search engine 210 communicates with the indexing engine 205 to generate a combined listing to satisfy the listing request. The combined listing includes a first listing of a plurality of listings associated with a first portion of the multiple-day length of stay parameter and a second listing of the plurality of listings associated with a second portion of the multiple-day length of stay parameter. For example, the combined listing can include a first stay or accommodation for the first five days of a ten day multiple-day length of stay parameter and a second stay or accommodation for the last five days of the ten day multiple-day length of stay parameter. In another example, the combined listing can include a first stay or accommodation for the first three days of a ten day multiple-day length of stay parameter and a second stay or accommodation for the last seven days of the ten day multiple-day length of stay parameter. Accordingly, the combined listing can include two or more listings that satisfy the multiple-day length of stay parameter in equal parts such that each listing corresponds to an equal share amount of time of the multiple-day length of stay parameter or the combined listing can include two or more listings that satisfy the multiple-day length of stay parameter in non-equal parts such that each listing corresponds to a non-equal share amount of time of the multiple-day length of stay parameter and the multiple-day length of stay parameter is divided unequally among the two or more listings.

In some examples, the search engine 210 conditions the generation and presentation of combined listings for a listing request based on whether a quantity of individual listings can satisfy the listing request by themselves. Namely, the search engine 210 searches to identify a set of individual listings of the plurality of listings that match the listing request. The search engine 210 determines that a quantity of listings in the set of listings fails to satisfy a minimum available inventory threshold. In such cases, the search engine 210 communicates with the indexing engine 205 to generate or obtain a combined listing. In this way, if the quantity of search results that are obtained that satisfy the listing request fail to meet some search quality assurance criterion (e.g., a minimum quantity), the search engine 210 can add or find more candidates to include in the search results by generating a combined listing from two or more of the listings that are included in the set of individual listings. The search engine 210 can continue generating additional combined listings until the search quality assurance criterion is met.

In some examples, the listing request includes a destination category or categories, such as national parks, beaches, surfing, camping, theme parks, or skiing destination. The search engine 210 conditions the generation and presentation of combined listings for a listing request based on whether a destination category is specified or selected by the listing request. In such cases, the search engine 210 communicates with the indexing engine 205 to generate or obtain a combined listing. In some examples, if a destination category is provided as part of the listing request, the search engine 200 can exclusively search for and present combined listings such that individual listings are not provided in the search results to the user.

In some examples, the indexing engine 205 generates combined listings in an offline basis or in real-time in response to receiving listing requests. The indexing engine 205 generates one or more combined listings by performing a set of operations. For example, the indexing engine 205 identifies a subset of individual listings of the plurality of listings that satisfies one or more search criteria of the listing request independent of the multiple-day length of stay parameter. The indexing engine 205, for each individual listing in the subset, generates a plurality of groups of stays on which the individual listing is available, each group of stays being associated with availability of the individual listing during different portions of the multiple-day length of stay parameter. The indexing engine 205 refines the plurality of groups using an aggregator based on a user profile of the searching end-user. The indexing engine 205 determines that a first combination of the portion of availability of a first refined group of a first individual listing in the subset with the portion of availability of a second refined group of a second individual listing matches the multiple-day length of stay parameter. The indexing engine 205, in response to determining that the first combination matches the multiple-day length of stay parameter, forms the combined listing based on the first refined group of a first individual listing and the second refined group of a second individual listing.

In some examples, each of the different portions includes a set of days starting from a start date and ending prior to an end date, and each of the different portions includes a set of days starting from a date later than the start date and ending on the end date. Namely, the indexing engine 205 forms pairs or combinations of individual listings that have equal or non-equal quantities of durations or lengths of stays (e.g., each listing can be reserved for 5 days for a 10 day entire stay and/or one listing can be reserved for 3 days for a 10 day entire stay and another for the remaining 7 days of the 10 day entire stay). For example, a first group of the stays on which the individual listing is available includes a first half of the multiple-day length of stay parameter, and a second group of the stays on which the individual listing is available includes a second half of the multiple-day length of stay parameter. Namely, the indexing engine 205 can form pairs or combinations of individual listings that have equal quantities of durations or lengths of stays (e.g., each listing can be reserved for 5 days for a 10 day entire stay).

In some examples, the indexing engine 205 can rank the different combinations of the individual listings. For example, the indexing engine 205 determines that a second combination of the portion of availability of the first refined group of the first individual listing with the portion of availability of a third refined group of a third individual listing also matches the multiple-day length of stay parameter. The indexing engine 205 computes a rank for the first and second combinations and selects either the first or second combination to generate the combined listing based on the computed rank of the first and second combinations. In some examples, the indexing engine 205 computes the rank for the first and second combinations based on individual ranks of the first, second and third individual listings (as determined by the first and second ranking processes/stages discussed above and below).

In some examples, the indexing engine 205 ranks the combined listings on the basis of whether the lengths of stays associated with the individual listings that form the combined listings are equal or non-equal and based on how much the lengths of stays differ. Namely, the indexing engine 205 can prioritize or rank higher those combined listings in which the length of stay is equally divided among the individual listings (e.g., 5 days stay in each of two listings for a total of a 10 day stay) over those listings in which the combined stay is non-equally distributed among the individual listings (e.g., one listing is used for 3 days of the 10 day stay and another for the remaining 7 days). As the individual listings become more unequally distributed in terms of lengths of stays, their respective combined listing is reduced in rank. Specifically, the indexing engine 205 computes a first difference between the portion of availability of the first refined group of the first individual listing and the portion of availability of the second refined group of the second individual listing. The indexing engine 205 computes a second difference between the portion of availability of the first refined group of the first individual listing and the portion of availability of the third refined group of the third individual listing. The indexing engine 205 associates a first rank with the first combination that is greater than a second rank associated with the second combination in response to determining that the first difference is smaller than the second difference.

In some examples, the indexing engine 205 ranks the combined listings on the basis of a compatibility level between the individual listings that form the combined listings. Namely, the indexing engine 205 can prioritize or rank higher those combined listings in which the individual listings are more compatible with each other. Specifically, the indexing engine 205 computes a first compatibility criterion between the first individual listing and the second individual listing. The indexing engine 205 computes a second compatibility criterion between the first individual listing and the third individual listing. The indexing engine 205 associates a first rank with the first combination that is greater than a second rank associated with the second combination in response to determining that the first compatibility criterion is associated with a higher level of compatibility than the second compatibility criterion. In some examples, compatibility criteria represent at least one of: quantity of overlapping listing attributes, quantity of listing attributes that match the user profile, price, image qualities, or distances between locations. Namely, two individual listings that are similar in price range and that are closer together or relate to the same type of destination can be associated with a higher compatibility criterion than other two individual listings that are only similar in price range.

In some examples, the search engine 200 determines that a given individual listing matches the listing request. In response, the search engine 200 excludes the given individual listing from being used as a basis to form one or more combined listings. In this way, greater diversity can be represented by the search results returned to the searching user. Namely, the search engine 200 can avoid repeating presentation of a particular individual listing if that individual listing completely fulfills the listing request and/or if that individual listing is included or not included as part of a combined listing. The individual listing can either be presented to an end user as an individually selectable listing or as part of a combined listing, but not both.

In some examples, the search engine 210 only includes combined listings in a display that is generated which have exclusive individual listings. Namely, the search engine 210 avoids presenting combined listings that share one or more individual listings. This further introduces disparity in the results presented to the user. Namely, the search engine 210 prevents presentation of a second combined listing in response to determining that the second combined listing includes the first listing that is also included in the first combined listing to introduce diversity in the presentation of the combined listing together with the one or more other listings.

In some examples, the search engine 210 determines whether the listing request includes a destination category. The search engine 210 modifies a level of flexibility in ranking and combining listings to form the combined listing based on determining that the listing request includes the destination category. Specifically, if the search engine 210 determines that the level of flexibility in ranking and combining corresponds to an inflexible threshold level, the search engine 210 increases a level of diversity among the listings used to form the combined listing.

In some examples, the search engine 210 determines that a distance between two individual listings falls within a threshold range that includes a minimum distance and a maximum distance. In such cases, the search engine 210 can include the two individual listings as candidates for being combined to form the combined listing. Specifically, the combined listing can be generated using first and second listings in response to the distance between the first and second listings being between the minimum distance and the maximum distance of the threshold range. This way, the search engine 210 can condition inclusion of two or more listings in a combined listing if the two or more listings are associated with respective destinations that are more than a threshold distance from each other but less than a maximum tolerable distance. This allows the user to visit a geographical location and stay at one of the accommodations of the first listing and easily travel to stay at the other accommodation of the second listing within the same trip. If the listings are associated with destinations that are too far apart (e.g., exceed the maximum distance threshold), the user is less likely to be interested in reserving the listings to consume during the same trip and so the search engine 210 can avoid including such listings in the combined listing.

In some examples, the search engine 210 obtains past interactions a searching end-user had with the network site. The search engine 210 can automatically select a destination category to base the generation of the combined listing based on the past interactions. The past interactions can include at least one of: filtering criteria, types of destinations searched for in a past threshold interval, price point of searched listings, or family status. For example, if the user previously searched for wineries within the last two weeks, the search engine 210 can automatically select a wineries destination category to use to search for and rank combined listings for presentation to the user.

In some examples, the search engine 210 applies one or more machine learning models (e.g., neural networks) to generate the combined listing, to generate the ranked order, to compare a first combined listing with a second combined listing, and/or to select whether to present a given listing as part of a given combined listing or as an individual listing in the presentation. Namely, the machine learning models can establish a relationship between features of individual listings and features of known or ground-truth combined listings. Using the relationship, the machine learning models can receive new features of a set of individual listings to generate a prediction as to whether or not to form combined listings from a subset of the individual listings and which of the individual listings would serve or result in high ranking combined listings and which would result in high ranking as individual listings.

Machine learning is a field of study that gives computers the ability to learn without being explicitly programmed. Machine learning explores the study and construction of algorithms, also referred to herein as tools, that may learn from existing data and make predictions about new data. Such machine-learning tools operate by building a model from example training data (e.g., listings data, combined listings data, individual listings data, and so forth) in order to make data-driven predictions or decisions expressed as outputs or assessments. Although examples are presented with respect to a few machine-learning tools, the principles presented herein may be applied to other machine-learning tools. In some examples, different machine-learning tools (models) may be used. For example, Logistic Regression (LR), Naive-Bayes, Random Forest (RF), neural networks (NN), matrix factorization, and Support Vector Machines (SVM) tools may be used for generating a combined listing, a ranked order, combined listing comparison and ranking, and/or to select whether a given individual listing is to form part of a given combined listing or is to serve as an individual listing in the presentation.

The machine-learning algorithms utilize features (e.g., various combinations of previously combined listings and/or combined listing rankings) for analyzing the data to generate assessments (e.g., determining whether or not to generate a combined listing, a ranked order, a combined listing comparison and ranking, and/or to select whether presentation of a given individual listing is to form part of a given combined listing or is to serve as an individual listing in the presentation). A feature is an individual measurable property of a phenomenon being observed. The concept of a feature is related to that of an explanatory variable used in statistical techniques such as linear regression. Choosing informative, discriminating, and independent features is important for effective operation in pattern recognition, classification, and regression. Features may be of different types, such as numeric features, strings, and graphs.

The machine-learning algorithms utilize the training data to find correlations among the identified features that affect the outcome or assessment (e.g., the known or ground truth attributes or features of combined listings and their rankings and the attributes of individual listings). In some examples, the training data includes labeled data, which is known data for one or more identified features and one or more outcomes, such as the set of features of previously combined listings and attributes of individual listings used and not used in the combined listings.

Once the training data are collected and processed, a machine learning model can be built using either statistical learning or machine learning techniques. In one example, regression analysis can be used to build the machine learning model. Regression analysis is a statistical process for estimating the relationships among variables. There are a number of known methods to perform regression analysis. Linear regression or ordinary least squares regression, among others, are “parametric” in that the regression function is defined in terms of a finite number of unknown model parameters that can be estimated from training data. For classification or suspension period modification prediction, a regression model (e.g., Equation 1) can be defined, for example, as:

H≈f(X,β), (Equation 1)

where “H” denotes the known combined listing attributes or features and/or individual listing attributes or features, “X” denotes a vector of input variables (e.g., listing features of a new set of individual or combined listings), and “β” denotes a vector of unknown parameters to be determined or trained for the regression model.

The training data that include features of previously combined listings and features of individual listings used and not used in the combination and the corresponding combinations of listings and associated rankings provide a set of known H values having corresponding X values (e.g., feature vectors extracted from the previously combined listings and features of individual listings). Using these data, the model parameter β can be computed using data fitting techniques such as least squares, maximum likelihood, or the like. Once β is estimated, the model can then compute H (e.g., determining whether or not to generate a combined listing, a ranked order, a combined listing comparison and ranking, and/or to select whether presentation of a given individual listing is to form part of a given combined listing or is to serve as an individual listing in the presentation) for a new set of X values (e.g., feature vectors extracted from a new set of individual and/or combined listings).

Machine learning techniques train models to accurately make predictions on data fed into the models. During a learning phase, the models are developed against a training dataset of inputs to optimize the models to correctly predict the output for a given input. Generally, the learning phase may be supervised, semi-supervised, or unsupervised, indicating a decreasing level to which the “correct” outputs are provided in correspondence to the training inputs. In a supervised learning phase, all of the outputs are provided to the model and the model is directed to develop a general rule or algorithm that maps the input to the output. In contrast, in an unsupervised learning phase, the desired output is not provided for the inputs so that the model may develop its own rules to discover relationships within the training dataset. In a semi-supervised learning phase, an incompletely labeled training set is provided, with some of the outputs known and some unknown for the training dataset.

Models may be run against a training dataset for several epochs (e.g., iterations), in which the training dataset is repeatedly fed into the model to refine its results. For example, in a supervised learning phase, a model is developed to predict the output for a given set of inputs and is evaluated over several epochs to more reliably provide the output that is specified as corresponding to the given input for the greatest number of inputs for the training dataset. In another example, for an unsupervised learning phase, a model is developed to cluster the dataset into n groups and is evaluated over several epochs as to how consistently it places a given input into a given group and how reliably it produces the n desired clusters across each epoch.

Once an epoch is run, the models are evaluated and the values of their variables are adjusted to attempt to better refine the model in an iterative fashion. In various aspects, the evaluations are biased against false negatives, biased against false positives, or evenly biased with respect to the overall accuracy of the model. The values may be adjusted in several ways depending on the machine learning technique used. For example, in a genetic or evolutionary algorithm, the values for the models that are most successful in predicting the desired outputs are used to develop values for models to use during the subsequent epoch, which may include random variation/mutation to provide additional data points. One of ordinary skill in the art will be familiar with several other machine learning algorithms that may be applied with the present disclosure, including linear regression, random forests, decision tree learning, neural networks, deep neural networks, and so forth.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the nth epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. In some examples, models that are finalized are evaluated against testing criteria. In a first example, a testing dataset that includes known outputs for its inputs is fed into the finalized models to determine an accuracy of the model in handling data on which it is has not been trained. In a second example, a false positive rate or false negative rate may be used to evaluate the models after finalization. In a third example, a delineation between data clusterings is used to select a model that produces the clearest bounds for its clusters of data. In some examples, the machine learning model is trained to establish a relationship to determine whether or not to generate a combined listing, a ranked order, a combined listing comparison and ranking, and/or to select whether presentation of a given individual listing is to form part of a given combined listing or is to serve as an individual listing in the presentation based on a logistic regression of one or more features (e.g., training data).

In some examples, the search engine 200 pre-generates many different combinations of combined listings (e.g., combinations of two or more individual listings). The generation can be based on a user-specified time period during which the user intends to travel and/or can be based on different sets of predetermined travel time periods (e.g., week stays). The different sets of predetermined travel time periods can be selected based on popular travel dates and/or travel dates previously selected by other users. As referred to herein, “travel dates” represent a multiple-day length of stay parameter of a search request during which a stay or experience at one or more places or locations is desired.

The search engine 210 identifies initially all listings that match a user-specified search criteria (e.g., number of bedrooms, location, photo quality, size, host type, and so forth) except for the travel dates or duration. After identifying all listings that match the user-specified search criteria, the search engine 210 accesses the travel dates or duration and breaks up the travel dates or durations into all or a variety of different combinations of dates or date portions. For example, if the travel dates range from April 1 through April 10, the search engine 210 can break up the travel dates into multiple separate dates ranging from April 1 to April 5, April 5 to April 10, April 8 to April 10, April 1 to April 3, and so forth. The search engine 210 breaks up the dates into a first collection of dates having a same start date and different end dates that precede the end date of the travel date input by the user. The search engine 210 breaks up the dates into a second collection of dates having a same end date and different start dates that follow the start date of the travel date input by the user. This allows the search engine 210 to identify multiple sets of individual listings that are available during a starting portion of the trip (e.g., the first collection of dates) and during an ending portion of the trip (e.g., the second collection of dates).

The search engine 210 searches all of the previously identified listings for those having availability during the first and second collections of dates. This search or filtering can be performed independent of a user profile and other parameters, such as listing rank. At the end of this initial search, the search engine 210 retrieves various collections of individual listings that match criteria input by a user or some other specified criteria and that are available at least during some starting or ending portion of a trip or travel dates. The search engine 210 processes these various collections to form multiple combined listings from the individual listings.

For example, the search engine 210 can select a first listing from a set of individual listings that are available during the starting portion (e.g., have availability during the first collection of dates) and can select a second listing from a set of individual listings that are available during the ending portion (e.g., have availability during the second collection of dates). The search engine 210 compares the first and second listings to ensure that the combined availability of the two listings overlaps or corresponds to the entire duration of the travel dates. Namely, the search engine 210 selects a second listing that has an availability that starts on the end date of the first listing and ends at the ending of the input travel dates. Alternatively, the search engine 210 selects a first listing that has an availability that ends on the starting date of the second listing and starts on the starting date of the travel dates. In some examples, the search engine 210 attempts to combine two individual listings that have equal amount of availability for the travel dates (e.g., each listing is available for half of the entire duration of stay).

The search engine 210 can filter these combined listings by one or more other criteria, such as a user profile, host ratings, price similarity, locations, individual listing rank, distance from each other, and so forth. In some cases, the search engine 210 only combines two listings into a single combined listing if the two individual listings have rankings that are within a threshold amount of each other. The search engine 210 can generate a combined listing rank.

In some cases, the search engine 210 conditions the generation and display of combined listings on determining that a listing request includes a particular parameter or criterion. For example, if the listing request includes one or more words that match a list of words associated with combined listing generation, the search engine 210 causes one or more combined listings to be generated and presented among a list of individual listings.

In some examples, the search engine 210 pre-combines all individual listings that have a similar criterion (e.g., national parks or vineyards, skiing categories, surfing categories, camping categories, golfing categories, tropical categories, world heritage, beach categories, lakefront categories, arctic categories, theme parks categories, iconic cities categories, countryside categories, design categories, amazing views categories, historic homes categories, offbeat categories, farms categories, and so forth). The search engine 210 searches a set of individual listings associated with the same or similar criterion and identifies a subset of the individual listings that are within a threshold distance range of each other (e.g., listings that are more than a minimum distance from each other and less than a maximum distance from each other). The search engine 210 can access a supply attribute and a uniqueness attribute of each listing or location and seasonality of the listings. Based on such attributes, the search engine 210 can form pairs of individual listings into combined listings for presentation to an end user.

### Flexible Search

In some examples, the search engine 210 receives input from the user requesting to perform a flexible search through listings. The level of flexibility can in some cases be specified by the user as a percentage which can be used to control the level of flexibility used to identify listings. In some examples, the search engine 210 receives a location via a search bar and receives input that selects a flexible search option in association with the location. This can instruct the search engine 210 to search through all available categories flexibly within a specified location. In some examples, the search engine 210 receives a user selection of a category and a flexible search option. This can instruct the search engine 210 to search flexibly through listings that match a certain selected category independent of location.

For example, in response to determining that a location was specified in association with the flexible search option, the search engine 210 can define a search region or boundary for the location. The boundary can be set based on a machine learning model or heuristics. For example, the boundary can be defined by first defining a minimum number of listings to include and search for in each category, such as based on a size of the category. The search engine 210 can find a predefined threshold of closest category listings to the center of the specified location. Specifically, the search engine 210 can access the listings in the location or within a certain distance of the location for each a set of categories (e.g., categories associated with the location). The search engine 210 can, for each category, find the specified threshold of closest listings within the category to the specified location. Then, the search engine 210 can draw a bounds that fits the specified threshold of closest listings for each category. In this way, the search engine 210 associates different retrieval bounds for each category associated with a particular location. A first category may be associated with a first bounds that is larger than a second bounds associated with a second category. This may be because to reach the specified threshold of closest listings, a larger radius or bounds or distance from the location may need to be drawn to reach a sufficient quantity of listings for the first category.

In some examples, in response to determining that a location was specified in association with the flexible search option, the search engine 210 defines a maximum closest results quantity to set the boundary for each category. The search engine 210 can compute the maximum distance of each listing in the results to a preferred bounding box associated with the location. The search engine 210 can compute or expand the bounding box to include a certain quantity of high quality listings that are within the maximum distance. Then the search engine 210 can sort the listings based on whether they are within the bounding box computed as relevant to the location. In some cases, the search engine 210 can demote or reduce a rank of listings that have a category cover image that is similar to higher ranked listings.

For example, in response to determining that a category was selected in association with the flexible search option, the search engine 210 can compute a boundary to search based on the category and one or more preferred locations which can be defined as a location of the user or locations associated with the selected category. The boundary can be set based on a machine learning model or heuristics. For example, the boundary can be defined by first defining a minimum number of listings to include and search for in each category, such as based on a size of the category. The search engine 210 can find a predefined threshold of closest category listings to location of the user or the location associated with the selected category. Specifically, the search engine 210 can access the listings in the location or within a certain distance of the location for the selected category. The search engine 210 can find the specified threshold of closest listings within the category to the specified location. Then, the search engine 210 can draw a bounds that fits the specified threshold of closest listings for the selected category.

In some examples, the search engine 210 computes the maximum distance of each listing in the results to a preferred bounding box associated with the location of the user or the category. The search engine 210 can compute or expand the bounding box to include a certain quantity of high quality listings that are within the maximum distance. Then the search engine 210 can sort the listings based on whether they are within the bounding box computed as relevant to the location of the user or associated with the category. In some cases, the search engine 210 can demote or reduce a rank of listings that have a category cover image that is similar to higher ranked listings.

FIG. 3 shows a listings network site user interface 300 (e.g., mobile application user interface, web browser user interface) generated by the listing network platform 142 and combined listing search system 150, according to some example embodiments. As illustrated, the user interface 300 includes a search field 310, a filters menu element 315 (e.g., place type, amenities), and a search button 320. The user enters a listings query into the search field 310, such as a search for temporary housing in San Francisco and a category limitation from the filters menu element 315 of “Entire Place” (e.g., the user seeks to rent the entire residence for said dates, as opposed to renting a private room in another person's residence). The user can customize the query directly using terms input into the search field 310 or filters listed via selection of the filters menu element 315. Further, the user can select dates using the dates drop-down element 317 to select a specific date range for the temporary stay. For example, the user can select the dates drop-down element 317 and a pop-up calendar (not depicted in FIG. 3) to specify the stay in San Francisco is to be specifically from Jul. 16, 2021 to Jul. 18, 2021.

Upon submitting the query (e.g., via selection of the search button 320, or automatically upon selecting the combined listings element 313 (split stays option) or dates drop-down element 317), the listings are displayed in the listings results area 305. The user can then select the listings or navigate to additional pages via page navigational elements 325. In some examples, the user interface 300 includes a set of combined listings 323 together with individual listings displayed in the results area 305. The combined listings 323 can be positioned within the display in a dedicated area, on top of the individual listings, between two individual listings, and/or underneath the individual listings. In some examples, the combined listings 323 are provided in response to receiving input that selects the combined listings element 313. In some examples, the combined listings 323 are presented automatically without receiving input that selects the combined listings element 313.

In some examples, the combined listings 323 are displayed in different slots or portions of the display relative to other individual listings on the basis of the type of client device being used to access the system. For example, on a mobile device, the combined listings 323 can be placed in slots 3, 6, 9, and 12 on the first page, and on a desktop computer, the same combined listings 323 may be presented in slots 5, 9, 14 and 20 for better visual balance. As referred to herein, the term “slots” means an area of a display in which a category is presented. In some cases, the combined listings 323 are excluded from being presented for last minute stays, such as if the travel dates are within 48 hours of check in or starting the trip. In some examples, the combined listings 323 include individual listings of destinations or stays that are at least two hours driving distance apart but no more than 10 hours driving distance apart. In some examples, the combined listings 323 excludes repeating pairs of the same individual listings. In some examples, the combined listings 323 relate to pairs of individual listings from different neighborhoods and locations. In such cases, neighborhoods and listings can be repeated across pairs of combined listings 323.

Using a specific example, a listing request can be received for a one month stay in Kauai specifying beachfront homes. In this example, the search engine 210 identifies only three individual listings that meet these search parameters but identifiers ten additional stays as combined listings 323. The combined listings 323 can represent opportunities to experience different sides of the island throughout the trip and can include an option to split time between two cities (e.g., Koloa and Hanalei), split time between two other cities (e.g., Koloa and Lihue), split time between two listings that are 1 mile apart in Koloa, split time in related cites (e.g., Poipu and Princeville) and/or related cities (e.g., Lihue and Princeville), and so forth. The result of selecting the combined listings element 313 or the search engine 210 automatically identifying combined listings without having a combined listings element 313 can provide 40% more unique inventory for the user to select that would be excluded if only individual listings were presented.

In some examples, the combined listings 323 presentation can vary based on the type of category selected. For example, if a national parks category is selected, the combined listings 323 can include two different national park points of interest that are at least two hours drive apart and a maximum of 10 hours drive apart. In some cases, if the national parks are very remote, they can still be paired even if their distances exceed these thresholds. The combined listings 323 graphical representation can visually identify the two national park listings that form part of the same combined listing without specifying the region/city name. As another example, if a surfing category is selected, two different surfing destinations can be selected that are two hours' drive apart and a maximum of 10 hours' drive apart. The combined listings 323 graphical representation can visually identify the two surfing destinations that form part of the same combined listing using the region/city name.

In some examples, the combined listings 323 are conditionally presented on the basis of the length of time of the travel dates specified by the user. For example, the search engine 210 can determine that the length of stay of a listing request is between 14 nights and 120 nights. In such cases, the search engine 210 automatically generates combined listings 323 for presentation to the user along with individual listings. In some cases, if the duration is between 60 and 120 nights, each individual listing included in the combined listings 323 can be limited to having a maximum availability of 60 nights. Namely, the combined listings 323 includes individual listings that are exactly 60 nights each.

In some examples, the combined listings 323 can be presented on a first region of a graphical user interface together with a map that is presented on a second region of the graphical user interface. In some cases, the map can represent a view of a first radius or range and can present listings available within the first radius or range. The search engine 210 can receive input that selects an individual combined listing from the combined listings 323. In response, the search engine 210 can present an icon, flag or indicator associated with a first listing of the individual combined listing. The icon, flag or indicator can be presented on a region of the map that corresponds to a location of the destination associated with the first listing. The search engine 210 can determine that a second listing that is included in the individual combined listing is associated with a destination that is more than a threshold distance away from the first listing destination and that is beyond a current zoom level (e.g., beyond the radius or range) of the currently displayed map. In such cases, the search engine 210 can present an indicator, such as a line or arrow, that starts at the icon, flag or indicator of the first listing and extends in a direction of the location of the second listing destination until the edge of the map that is presented. This informs the user about the link between the first and second listings in the individual combined listing and alerts the user about where the second listing is relative to the first listing even though the second listing corresponds to a destination that is outside of the current map view.

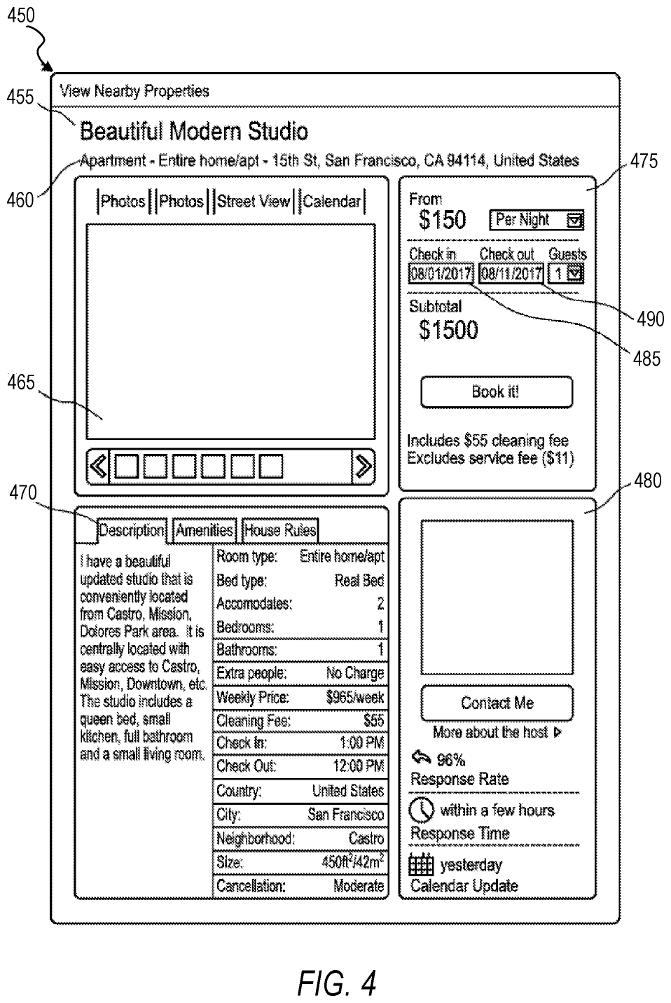

FIG. 4 illustrates an example user interface 450 for a description of a listing for a rental item (e.g., an apartment in San Francisco posted to a listings network site by a posting user, for example, the apartment owner), according to some example embodiments. The user interface 450 is an example listing that can be displayed, for example, in response to the user selecting the first listing (“LISTING 1”) in the listings results area 305 in FIG. 3. As illustrated, the example listing shown in FIG. 4 is for accommodations in San Francisco. In other examples, the listing could be for a tour, local experience, transportation, or other trip item. The listing may include a title 455 and a brief description 460 of the rental item. The listing may further include photos of the rental item, maps of the area or location associated with the rental item, a street view of the rental item, a calendar of the rental item, and so forth, which may be viewed in area 465. The listing may include a detailed description 470, pricing information 475, and the listing host's information 480. The listing may further allow a user to update a date range for the rental item by entering or choosing specific check-in date element 485 and check-out date element 490. In some examples, the listing in user interface 450 corresponds or represents an individual listing. In some examples, the listing in user interface 450 represents content of two or more individual listings, such as when a user selection of a combined listing is received from the listings results area 305 of FIG. 3.

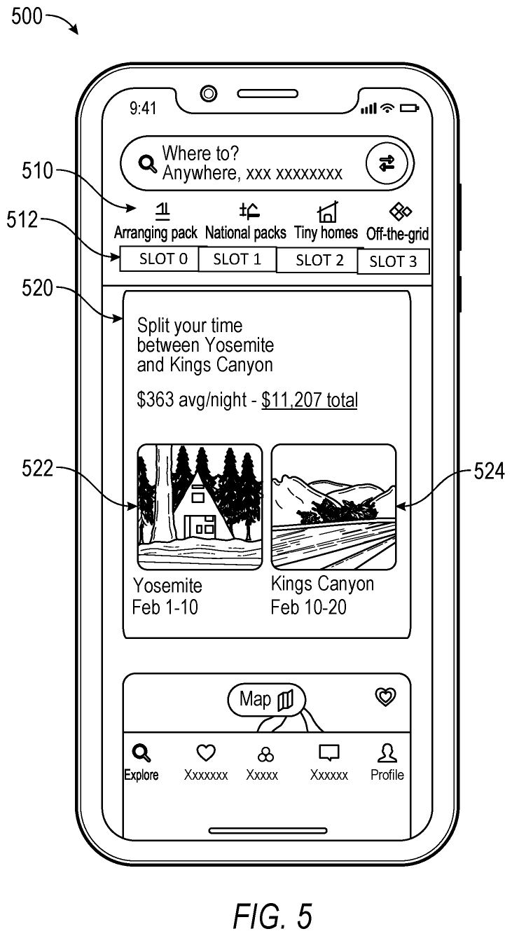

FIG. 5 illustrates an example user interface 500 for results provided in response to a listing request. As shown in user interface 500, a user selection of a listing criterion 510 (e.g., a category or destination category) can be received (e.g., national parks). The user interface 500, as part of the listing criterion 510, can also receive input that specifies travel dates (e.g., a multiple-day length of stay parameter). In response, the search engine 210 identifies and generates a combined listing 520 that includes a first individual listing 522 and a second individual listing 524. The combined listing 520 can be generated by identifying the first individual listing 522 that has availability during a first portion of the travel dates and by identifying the second individual listing 524 that has availability during a second adjacent portion of the travel dates. The combined listing 520 can also provide the availability dates or the way in which the travel dates were split along with visual graphical representations of the first and second individual listings that form the combined listing 520. The combined listing 520 can include a message recommending to the user to split their time between two different national parks or two different destinations associated with the listing criterion.

### Category Ranking

In some examples, the computing device displaying the user interface 500 ranks the listing criterion 510 according to various parameters. Specifically, the computing device can retrieve a plurality of listing categories, rank the categories, and present the categories in respective category slots 512 (e.g., slot 0, slot 1, slot 2, slot 3, and so forth) of the user interface 500. The ranking of the categories (also referred to as the listing criteria) can be performed based on search criteria received from the user, a current season (or season associated with travel dates specified by the user), a destination or location being searched, the amount of inventory or listings available to be reserved for each respective category, and any other suitable parameters. For example, if a search request or search criteria includes ski resorts or a location that is associated with ski vacations, a cabins category can be ranked higher than a beaches category. In such cases, the cabins category can be presented in slot 0 of the category slots 512 and the beaches category can be displayed in slot 3 or not at all. In response to the user selecting the cabins category from slot 0, a set of listings associated with the cabins category are presented according to their respective ranks (discussed above). As another example, if the search request specifies Paris as a location, a castles category can be ranked the highest and presented in slot 0 while a beaches category or cabins category is displayed in slot 3 or not at all. This may be because the location Paris can be associated with a large quantity of listings that match the castles category and very few listings that match the cabins or beaches categories.

For each location, the computing device can find categories that are popular or ranked high or above a threshold for the particular location. For example, a Napa location can be associated with a vineyard category and chef's kitchen and pool. The categories can also be ranked based on uniqueness of the category to each particular location. In some examples, computing device (using the indexing engine 205 and/or search engine 210) ranks the categories for a location by popularity and uniqueness. Then, the computing device divides the categories into a plurality of themes (e.g., a surprising theme, familiar theme, and activity theme). The categories are also divided into various tiers or groups based on their relative importance to the respective tiers or groups. In some examples, the categories are ranked by combining signals representing the category popularity, uniqueness, tier, and/or expert opinion.

In some examples, the computing device selects one category from each theme to present to the user. The user computing device associates a first theme with a first slot of the category slots 512 (e.g., slot 0), a second theme with a second slot of the category slots 512 (e.g., slot 1), and a third theme with a third slot of the category slots 512 (e.g., slot 2) and then repeats the cycle for the remaining slots. The computing device can search categories associated with the first theme for a first category having a highest rank or can randomly select the first category from the first theme. The computing device can then present the selected first category in the slot associated with the first theme (e.g., slot 0) in the user interface 500. The computing device can search categories associated with the second theme for a second category having a highest rank or can randomly select the second category from the second theme. The computing device can then present the selected second category in the slot associated with the second theme (e.g., slot 1). The computing device can continue populating categories into the slots by searching the respectively associated themes of the slots.

The computing device can dynamically and over time change the assignment of the themes to the slots 512. For example, the theme assignments can vary based on an intent of the user. Specifically, when a user opens the user interface 500 (first accesses the user interface 500) with no recent search being performed in less than a threshold number of days (e.g., 30 days), the computing device showcases the breadth and depth of possibilities around the user and beyond, based on a season, a location of the user and a user profile. As another example, when a user has entered a destination in the search criteria, the computing device showcases the categories related to this search with inventory or listings available in the searched location or within a certain distance of the searched location. These categories selected are personalized based on search filters, for example the price filter or the guest count. When a user comes back after a recent destination search (less than 30 days ago), the user interface 500 helps the user continue and expand their search by showcasing categories related to the location they searched for previously. For example, the ski-in/out category can be presented in the first slot if the user searched for a ski destination (e.g., Tahoe) the last time the user visited the user interface 500 and the computing device determines that it is currently ski season.

Specifically, in some examples, if no destination is specified in the user's search criteria, the computing device can associate a featured theme with the first slot 0, a surprising theme with the second slot 1, an activity theme with the third slot 2, and a familiar theme with slot 3. For example, if a destination is specified in the user's search criteria, the computing device can associate an all homes theme with the first slot 0, a familiar theme with the second slot 1, a surprising theme with the third slot 2, and an activity theme with slot 3. As another example, if no destination is specified in the user's search criteria and a recent search (within a threshold period of time of 30 days) has been performed, the computing device can associate no theme with the first slot 0, an activity theme with the second slot 1, a surprising theme with the third slot 2, and a familiar theme with slot 3.

To personalize the display of the categories in the user interface 500, the computing device can determine if a specified destination in a listing search matches a variety of listings that are associated with a same category. Namely, if a majority of the listings matching a search correspond to a particular category, the computing device prevents the particular category from being presented in any of the category slots or presents the category in the last few category slots. Also, the computing device can determine that two categories have a level of similarity that exceeds a threshold. In such cases, the computing device prevents presenting the two categories in the same screen (e.g., beachfront category is very similar to beach; skiing category is very similar to ski-in/out; and lakefront category is similar to lakehouse category). In some examples, the computing device can determine the current season or the season associated with travel dates specified in a search criteria. The computing device can identify one or more categories that are not relevant to the current season or the season associated with the travel dates. Such one or more categories are then ranked very low and displayed in later category slots or are not at all presented. For example, skiing category can only be presented in a winter season and not in a summer season.

To further personalize the display of categories, the computing device can consider the user's previous or current destination searches. For example, the computing device determines the price of past bookings or a price of a filter provided by the user. Such price can be used to increase ranking of categories with higher price points if the price filter being applied is higher than a threshold or if the user previously booked listings with prices higher than an average price. Also, if the user's search criteria includes adult and/or a children count, the computing device can increase ranking of family-friend categories, such as theme parks, amazing pools, farms, and so forth. The computing device can also increase the ranking of solo-friendly categories if the guest count provided by the user is 1 or 2, such as shared home categories, domes, bed & breakfast, and so forth. The computing device can also include ranking of group-friendly categories if the search criteria specifies a group of more than a threshold number of guests. In some examples, the computing device determines that certain categories were not selected in the past by the user or are associated with listings that fail to match a user profile. The computing device can decrease the ranking of such categories.

In some examples, the computing device communicates with the indexing engine 205 and/or the search engine 210 to obtain and compute a ranking for each category that is associated with a geographical location (e.g., a location specified by a listing search request). The indexing engine 205 can apply a heuristic and/or a machine learning model to parameters associated with categories of the location to compute the ranking for each category. In some examples, the indexing engine 205 bases the ranking on a quantity of inventory associated with each category and a uniqueness of the category. The quantity of inventory can be determined by finding or computing how many listings are both (i) within a threshold distance of the location and (ii) associated with a particular category (this can be denoted as inv(c ,g)), where c is a particular category and g is a geographical location. The indexing engine 205 can compute a uniqueness of each category in accordance with the following equation:

unig(c, g)=(inv(c, g)/inv(g))/(inv(c)/inv( ))

where inv(c, g) represents the total amount of listings associated with the particular category c in the location g, inv(g) represents the total amount of listings associated with the geographical location g, inv(c) represents the total amount of listings associated with the particular category c, and inv( )represents the total amount of inventory that is available to the indexing engine 205.

Specifically, the numerator of the above equation for unig(c, g) is the percentage of listings in a geographical location that belong to a category and the denominator is the percentage of global listings that belong to a category. In this way, the uniqueness of a category unig(c, g) is represented as a ratio of the percentage of listings in a geographical location that belong to a category to the percentage of global listings that belong to the category. In some examples, categories with greater uniqueness values are ranked higher than categories with lower uniqueness values. In some examples, categories with smaller uniqueness values are ranked higher than categories with higher uniqueness values.

When computing the inventory and uniqueness of a category, the indexing engine 205 can, by default, generate a bounding box that centers at the center of the specified location and expands a threshold distance (e.g., 100 miles plus one standard deviation) to reach a listing location that is in the bounding box. In some cases, the same threshold distance is used for each category. In some cases, different threshold distances for the bounding boxes are used for different categories. For example, people often are willing to drive for hours to ski and some other people are willing to fly thousands of miles to stay in a castle but few people may be willing to drive more than one hour to use a pool.

In some examples, local, region and global ranges can be associated with various categories. Local category ranges can include categories that are associated with pools, bed and breakfast, grand pianos, and so forth. Regional category ranges can include categories corresponding to experiences for which people are willing to spend at most a few hours on the road, such as a beachfront, national parks and vineyards. For such regional category ranges, the bound box can center at the center of the location and expands a threshold distance (100 miles plus one standard deviation of listing latitude/longitude in the location). If no location is specified by a user search criteria, the threshold distance can be set to a greater value (e.g., 200 miles) from the current location of the user.

Global category ranges can include categories corresponding to areas that are worthy of taking a flight, such as castles, surfing and so forth. For such category ranges, the threshold distance of the bounding box can be set to infinity or a very large number to capture the entire globe. If a specified location is provided by a user search criteria, the threshold distance of the global category ranges can be set to the same values as the regional category ranges. This may be because indexing engine 205 may avoid showing categories that do not apply to the area being searched (e.g., showing “Castles” when a user searches for “San Francisco”).

In some examples, the indexing engine 205 receives inputs from experts in the specific locations that rank the various categories as their relevance to the specific locations. The indexing engine 205 can assign ranks to the categories, such as very good, good, acceptable, and unacceptable. The indexing engine 205 can compute a final score for each category based on an average of the following parameters: logio(inv(c, g))+sqrt(unig(c, g); the expert score associated with the category; and an automatically or manually set score by an operator of the indexing engine 205. Sqrt represents a square root function.

In some examples, the indexing engine 205 trains a machine learning model (e.g., a neural network) to predict bookings or likelihood of a user booking a stay in a listing associated with each category. The machine learning model is trained to predict bookings in each category. In some examples, the machine learning model receives signals from a search query or search criteria including one or more of a specified geographical location, number of guests, number of children, number of nights, lead days, which filters are applied, and so forth. The machine learning model can processes the signals and predicts a likelihood that a user will select a search result listing in a particular category and book a stay associated with the listing. In some examples, the machine learning model is implemented using a feed forward network with two hidden layers where it has an input for each input signal and an output for each category. The output can be a likelihood value for each category indicating a likelihood or prediction that a listing in the category will be selected and booked.

In one example, the machine learning model is trained using historical training data that includes various categories, search parameters and ground truth bookings. The machine learning model receives a set of the training data including the search parameters and categories and can extract a set of features which are used to generate a prediction of booking in each category. The prediction is compared to the ground truth booking information for the training data and parameters of the machine learning model are updated. The machine learning model processes additional training data in a similar manner until a convergence criterion or stopping criterion is met.

In response to receiving a search criteria, the search parameters and user history are converted into a set of features and fed into the trained machine learning model. The trained machine learning model generates a prediction for each category indicating a likelihood that a listing in the category will be booked. The probabilities output by the model can be aggregated in order to generate or associate a uniqueness value with each category. For example, the uniqueness value of each category can be computed based on the predicted probability of the category divided by the average predicted probability of that category in all geographical locations. The probability is used to generate a score for each category as a combination of the predicted probability and the uniqueness. In some cases, the uniqueness that is considered for the score is heuristically determined using the above equation for unig(c, g).

The rankings for the categories determined by the indexing engine 205 can then be used to select a category from a list of categories associated with a theme that is assigned a particular slot. The selected category is then presented in the user interface 500 in the corresponding slot for the theme.

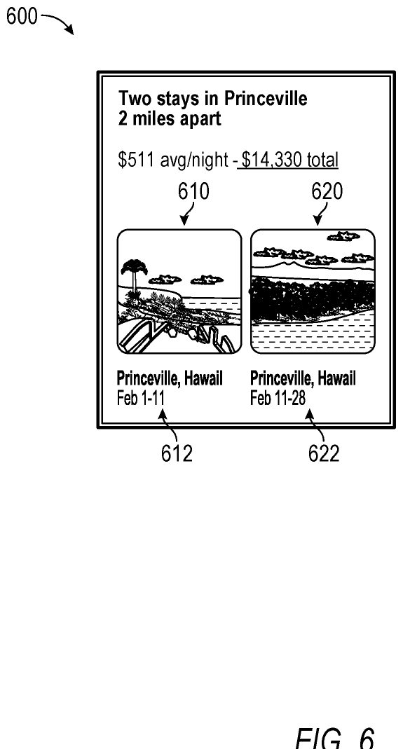

FIG. 6 illustrates an example user interface 600 for results provided in response to a listing request (or search criteria or search request). User interface 600 includes a combined listing of two individual listings matching a listing criterion (e.g., a particular city). The combined listing in user interface 600 can be generated by identifying a first individual listing 610 that has availability during a first portion of the travel dates and by identifying a second individual listing 620 that has availability during a second, adjacent portion of the travel dates. The combined listing can also provide the availability dates 612 and 622 or the way in which the travel dates were split along with visual graphical representations of the first and second individual listings 610, 620 that form the combined listing. The combined listing can include a message recommending to the user to split their time between two different cities associated with the listing criterion.

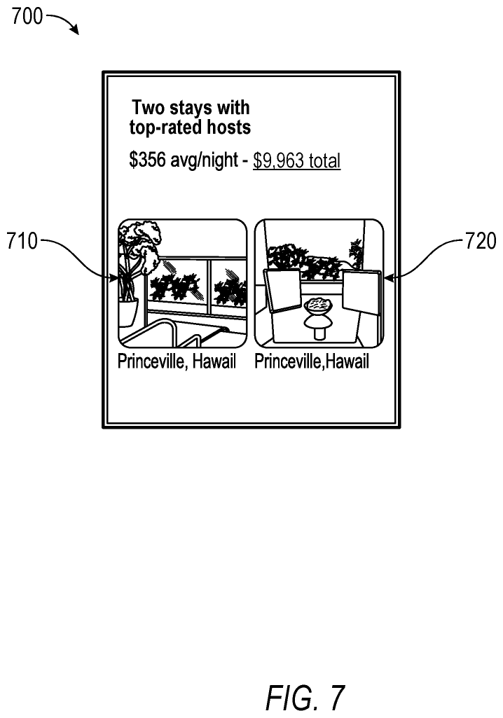

As shown in FIG. 7, a user interface 700 can be provided in which a combined listing that includes individual listings matching a same search criterion is presented. The user interface 700 includes a message identifying first and second individual listings 710 and 720 that form the combined listing and that indicate that the two listings are associated with top-rated hosts. Namely, the message can inform the user about the attribute common to the individual listings that was used to form a combined listing that resulted in the combined listing having a certain high rank.

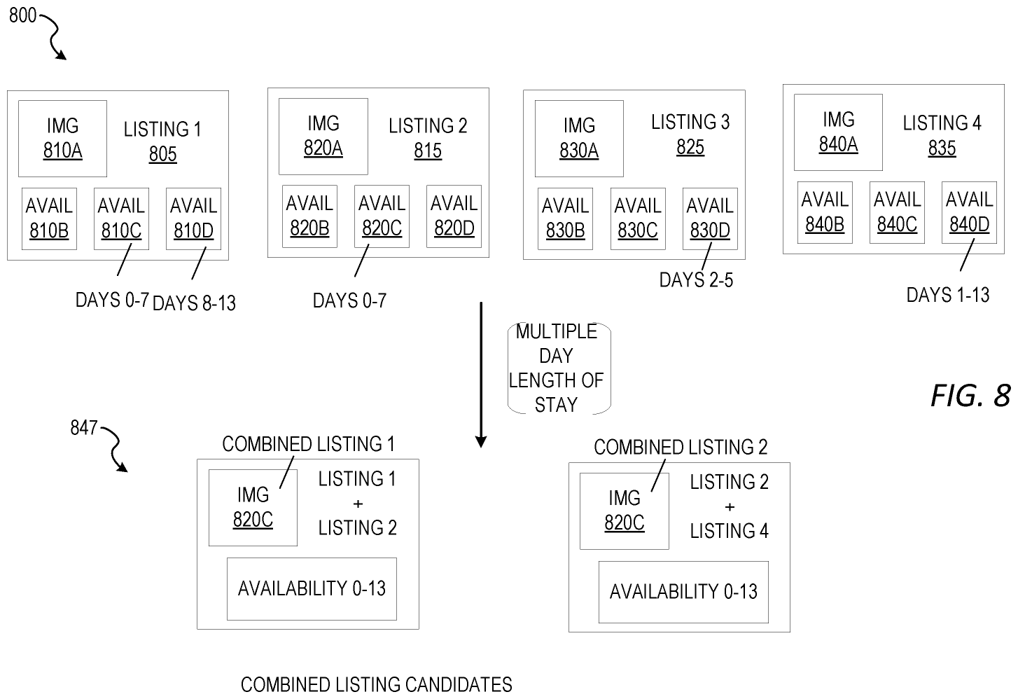

FIG. 8 shows a diagram 800 for combined listing searches, according to some examples. The process shown in diagram 800 is performed in order to generate a set of combined listings 847 given a listing request. Specifically, a set of individual listings including a first listing 805, a second listing 815, a third listing 825, and a fourth listing 835 can be identified. The individual listings can be identified by searching respective images 810A, 820A, 830A, 840A among other parameters that satisfy a listing request except for the multiple-day length of stay parameter of the listing request. Namely, the first listing 805, second listing 815, third listing 825, and fourth listing 835 can be identified as listings that match one or more criteria regardless of the travel time periods.

Next, the travel time period is accessed and used to search respective availability dates 810B, 810C, 810D of the first listing 805; the availability dates 820B, 820C, 820D of the second listing 815; the availability dates 830B, 830C, 830D of the third listing 825; and the availability dates 840B, 840C, 840D of the fourth listing 835. Namely, the search engine 210 accesses the travel dates or duration and breaks up the travel dates or durations into all or a variety of different combinations of dates or date portions. For example, if the travel dates range from April 1 through April 10, the search engine 210 can break up the travel dates into multiple separate dates ranging from April 1 to April 5, April 5 to April 10, April 8 to April 10, April 1 to April 3, and so forth. The search engine 210 breaks up the dates into a first collection of dates having a same start date and different end dates that precede the end date of the travel date input by the user. The search engine 210 breaks up the dates into a second collection of dates having a same end date and different start dates that follow the start date of the travel date input by the user. This allows the search engine 210 to identify multiple sets of individual listings that are available during a starting portion of the trip (e.g., the first collection of dates) and during an ending portion of the trip (e.g., the second collection of dates). Specifically, the search engine 210 can determine that the first listing 805 is available on days 0-7 and on days 8-13 of the travel dates.

Namely, the search engine 210 selects the first listing 805 available during the starting portion (e.g., has availability during the first collection of dates, days 0-7) and selects the second listing 815 that is available during the ending portion (e.g., has availability during the second collection of dates, days 8-13). The search engine 210 forms a first combined listing that includes the first listing 805 and the second listing 815. The search engine 210 also determines that the second listing 815 has availability during the first portion of the travel dates, which, combined with the availability during a second portion of the travel dates of fourth listing 835, corresponds to the entire length of stay. In such cases, the search engine 210 generates a second combined listing that includes the second listing 815 and the fourth listing 835. The search engine 210 compares the first and second listings to ensure that the combined availability of the two listings overlaps or corresponds to the entire duration of the travel dates (days 0-13). In some cases, the search engine 210 attempts to combine two individual listings that have equal amount of availability for the travel dates (e.g., each listing is available for half of the entire duration of stay).

The search engine 210 can then rank the two combined listings to select one of the combined listings for presentation to the user in the user interfaces, discussed above. In some cases, the search engine 210 presents all of the possible combined listing candidates in a ranked order among other individual listings. In some examples, the search engine 210 can exclude certain combined listings if one or more criteria is or is not met. For example, the search engine 210 can exclude a combined listing that includes an individual listing that is available during the entire length of the stay.

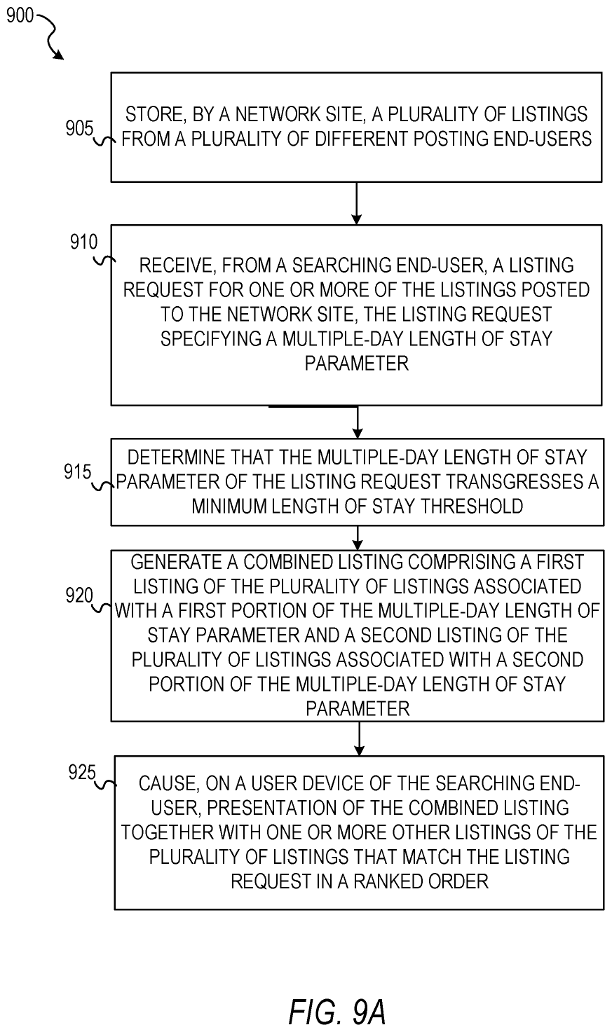

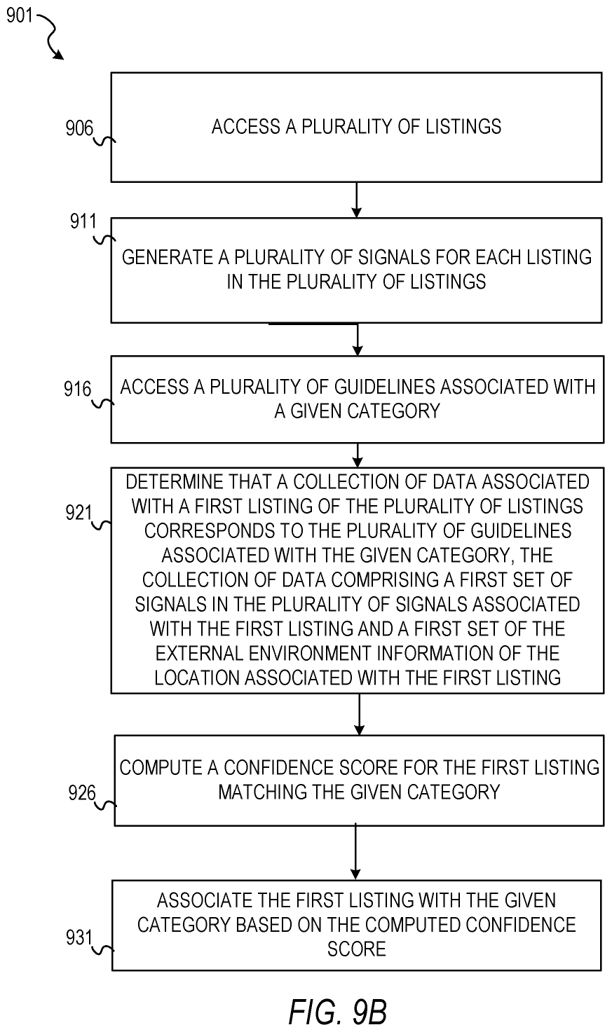

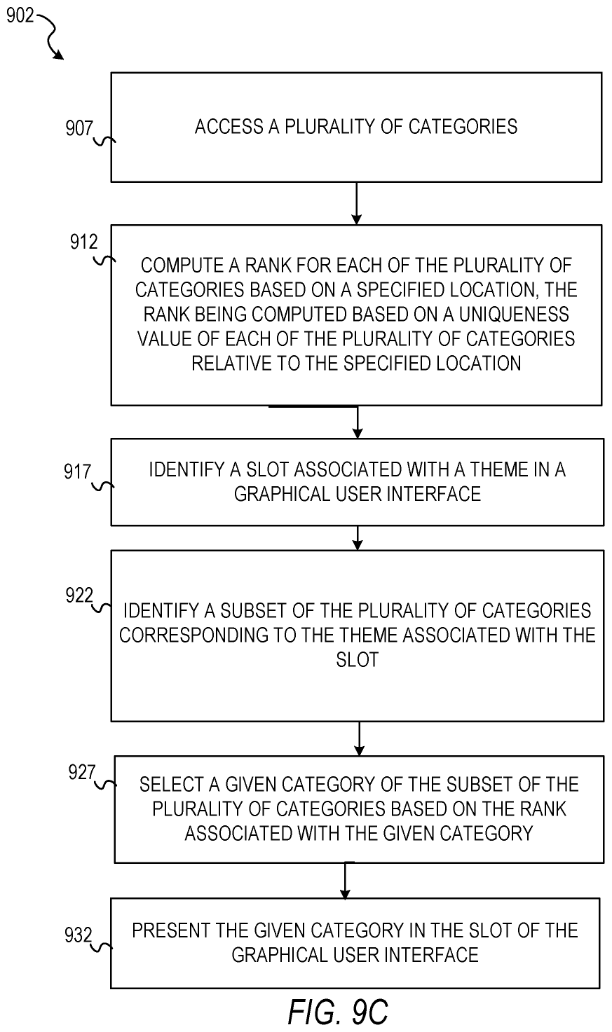

FIG. 9A shows an example flow diagram of a method 900 for generating combined listing results, according to some example embodiments.

At operation 905, the combined listing search system 150 stores, by a network site, a plurality of listings from a plurality of different posting end-users, as discussed above.

At operation 910, the combined listing search system 150 receives, from a searching end-user, a listing request for one or more of the listings posted to the network site, the listing request specifying a multiple-day length of stay parameter, as discussed above.

At operation 915, the combined listing search system 150 determines that the multiple-day length of stay parameter of the listing request transgresses a minimum length of stay threshold, as discussed above.

At operation 920, the combined listing search system 150, in response to determining that the multiple-day length of stay parameter of the listing request transgresses the minimum length of stay threshold, generates a combined listing comprising a first listing of the plurality of listings associated with a first portion of the multiple-day length of stay parameter and a second listing of the plurality of listings associated with a second portion of the multiple-day length of stay parameter, as discussed above.

At operation 925, the combined listing search system 150 causes, on a user device of the searching end-user, presentation of the combined listing together with one or more other listings of the plurality of listings that match the listing request in a ranked order, as discussed above.

FIG. 9B shows an example flow diagram of a method 901 for generating combined listing results, according to some example embodiments.

At operation 906, the combined listing search system 150 accesses a plurality of listings, as discussed above.

At operation 911, the combined listing search system 150 generates a plurality of signals for each listing in the plurality of listings, as discussed above. For example, the combined listing search system 150 obtains external environment information for a location associated with each listing.

At operation 916, the combined listing search system 150 accesses a plurality of guidelines associated with a given category, as discussed above.

At operation 921, the combined listing search system 150 determines that a collection of data associated with a first listing of the plurality of listings corresponds to the plurality of guidelines associated with the given category, the collection of data comprising a first set of signals in the plurality of signals associated with the first listing and a first set of the external environment information of the location associated with the first listing, as discussed above.

At operation 926, the combined listing search system 150 computes a confidence score for the first listing matching the given category, as discussed above.

At operation 931, the combined listing search system 150 associates the first listing with the given category based on the computed confidence score, as discussed above.

FIG. 9C shows an example flow diagram of a method 902 for generating combined listing results, according to some example embodiments.

At operation 907, the combined listing search system 150 accesses a plurality of categories, as discussed above.

At operation 912, the combined listing search system 150 computes a rank for each of the plurality of categories based on a specified location, the rank being computed based on a uniqueness value of each of the plurality of categories relative to the specified location, as discussed above.

At operation 917, the combined listing search system 150 identifies a slot associated with a theme in a graphical user interface, as discussed above.

At operation 922, the combined listing search system 150 identifies a subset of the plurality of categories corresponding to the theme associated with the slot, as discussed above.

At operation 927, the combined listing search system 150 selects a given category of the subset of the plurality of categories based on the rank associated with the given category, as discussed above.

At operation 932, the combined listing search system 150 presents the given category in the slot of the graphical user interface, as discussed above.

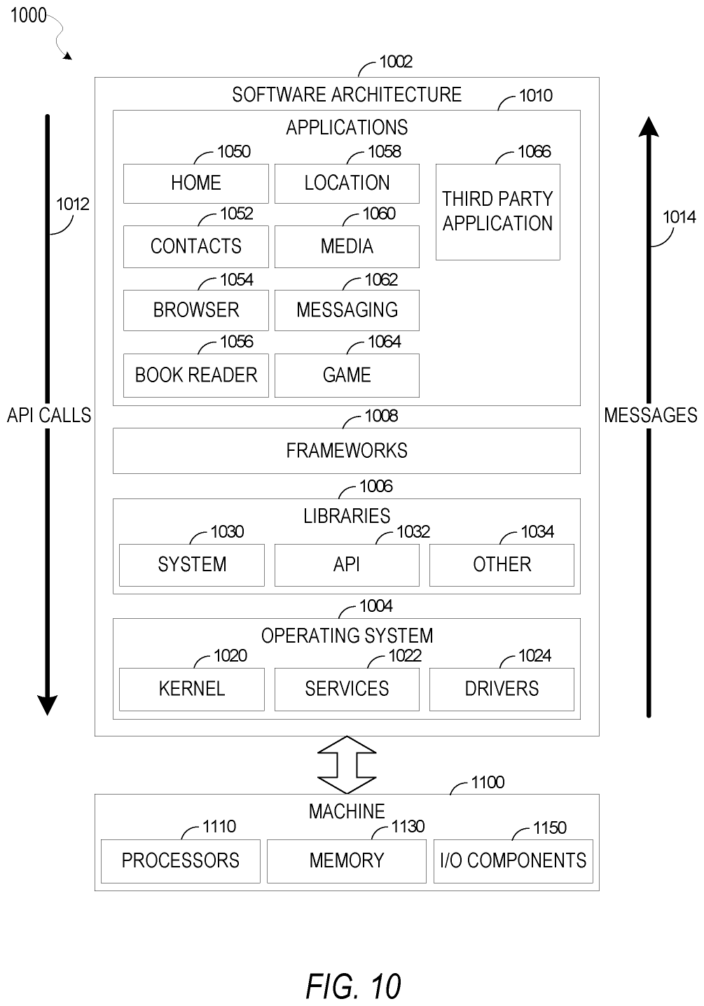

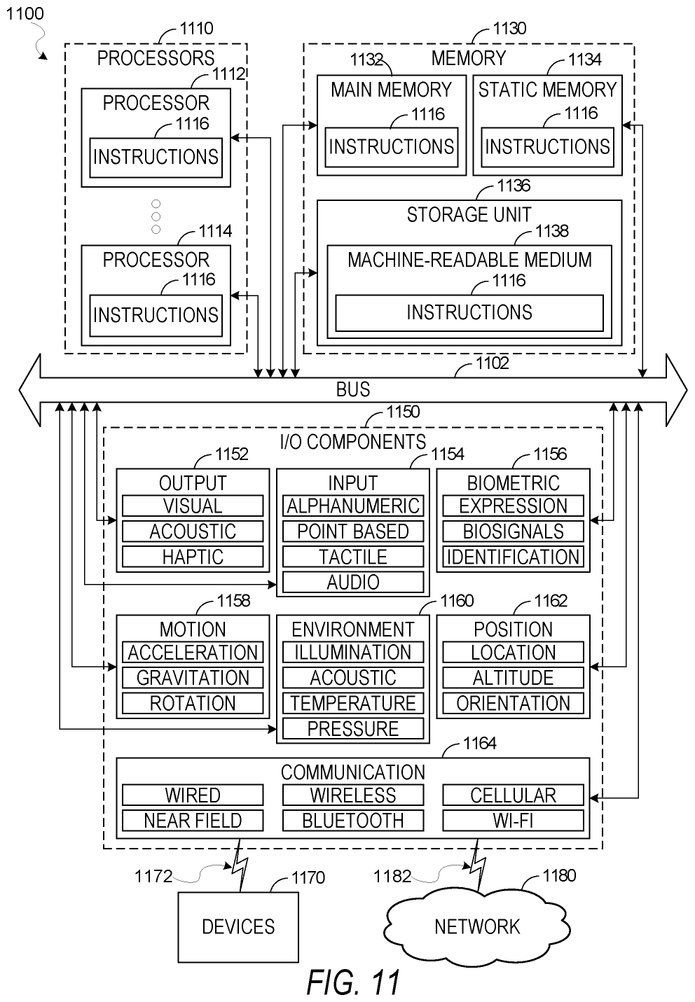

FIG. 10 is a block diagram 1000 illustrating an architecture of software 1002, which can be installed on any one or more of the devices described above. FIG. 10 is merely a non-limiting example of a software architecture, and it will be appreciated that many other architectures can be implemented to facilitate the functionality described herein. In various embodiments, the software 1002 is implemented by hardware such as a machine 1100 of FIG. 11 that includes processors 1110, memory 1130, and input/output (I/O) components 1150. In this example architecture, the software 1002 can be conceptualized as a stack of layers where each layer may provide a particular functionality. For example, the software 1002 includes layers such as an operating system 1004, libraries 1006, frameworks 1008, and applications 1010. Operationally, the applications 1010 invoke API calls 1012 through the software stack and receive messages 1014 in response to the API calls 1012, consistent with some embodiments.

In various implementations, the operating system 1004 manages hardware resources and provides common services. The operating system 1004 includes, for example, a kernel 1020, services 1022, and drivers 1024. The kernel 1020 acts as an abstraction layer between the hardware and the other software layers, consistent with some embodiments. For example, the kernel 1020 provides memory management, processor management (e.g., scheduling), component management, networking, and security settings, among other functionality. The services 1022 can provide other common services for the other software layers. The drivers 1024 are responsible for controlling or interfacing with the underlying hardware, according to some embodiments. For instance, the drivers 1024 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

In some embodiments, the libraries 1006 provide a low-level common infrastructure utilized by the applications 1010. The libraries 1006 can include system libraries 1030 (e.g., C standard library) that can provide functions such as memory allocation functions, string manipulation functions, mathematic functions, and the like. In addition, the libraries 1006 can include API libraries 1032 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1006 can also include a wide variety of other libraries 1034 to provide many other APIs to the applications 1010.

The frameworks 1008 provide a high-level common infrastructure that can be utilized by the applications 1010, according to some embodiments. For example, the frameworks 1008 provide various graphic user interface (GUI) functions, high-level resource management, high-level location services, and so forth. The frameworks 1008 can provide a broad spectrum of other APIs that can be utilized by the applications 1010, some of which may be specific to a particular operating system or platform.

In an example embodiment, the applications 1010 include a home application 1050, a contacts application 1052, a browser application 1054, a book reader application 1056, a location application 1058, a media application 1060, a messaging application 1062, a game application 1064, and a broad assortment of other applications such as a third-party application 1066. According to some embodiments, the applications 1010 are programs that execute functions defined in the programs. Various programming languages can be employed to create one or more of the applications 1010, structured in a variety of manners, such as object-oriented programming languages (e.g., Objective-C, Java, or C++) or procedural programming languages (e.g., C or assembly language). In a specific example, the third-party application 1066 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1066 can invoke the API calls 1012 provided by the operating system 1004 to facilitate the functionality described herein.

FIG. 11 illustrates a diagrammatic representation of a machine 1100 in the form of a computer system within which a set of instructions may be executed for causing the machine to perform any one or more of the methodologies discussed herein, according to an example embodiment. Specifically, FIG. 11 shows a diagrammatic representation of the machine 1100 in the example form of a computer system, within which instructions 1116 (e.g., software, a program, an application, an applet, an app, or other executable code) for causing the machine 1100 to perform any one or more of the methodologies discussed herein may be executed. The instructions 1116 transform the general, non-programmed machine 1100 into a particular machine 1100 programmed to carry out the described and illustrated functions in the manner described. In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a PC, a tablet computer, a laptop computer, a netbook, an STB, a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1116, sequentially or otherwise, that specify actions to be taken by the machine 1100. Further, while only a single machine 1100 is illustrated, the term “machine” shall also be taken to include a collection of machines 1100 that individually or jointly execute the instructions 1116 to perform any one or more of the methodologies discussed herein.

The machine 1100 may include processors 1110, memory 1130, and I/O components 1150, which may be configured to communicate with each other such as via a bus 1102. In an example embodiment, the processors 1110 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1112 and a processor 1114 that may execute the instructions 1116. The term “processor” is intended to include multi-core processors that may comprise two or more independent processors (sometimes referred to as “cores”) that may execute instructions contemporaneously. Although FIG. 11 shows multiple processors 1110, the machine 1100 may include a single processor with a single core, a single processor with multiple cores (e.g., a multi-core processor), multiple processors with a single core, multiple processors with multiples cores, or any combination thereof.

The memory 1130 may include a main memory 1132, a static memory 1134, and a storage unit 1136, all accessible to the processors 1110 such as via the bus 1102. The main memory 1132, the static memory 1134, and storage unit 1136 store the instructions 1116 embodying any one or more of the methodologies or functions described herein. The instructions 1116 may also reside, completely or partially, within the main memory 1132, within the static memory 1134, within the storage unit 1136, within at least one of the processors 1110 (e.g., within the processor's cache memory), or any suitable combination thereof, during execution thereof by the machine 1100.

The I/O components 1150 may include a wide variety of components to receive input, provide output, produce output, transmit information, exchange information, capture measurements, and so on. The specific I/O components 1150 that are included in a particular machine will depend on the type of machine. For example, portable machines such as mobile phones will likely include a touch input device or other such input mechanisms, while a headless server machine will likely not include such a touch input device. It will be appreciated that the I/O components 1150 may include many other components that are not shown in FIG. 11. The I/O components 1150 are grouped according to functionality merely for simplifying the following discussion and the grouping is in no way limiting. In various example embodiments, the I/O components 1150 may include output components 1152 and input components 1154. The output components 1152 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1154 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1150 may include biometric components 1156, motion components 1158, environmental components 1160, or position components 1162, among a wide array of other components. For example, the biometric components 1156 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1158 may include acceleration sensor components (e.g., accelerometer), gravitation sensor components, rotation sensor components (e.g., gyroscope), and so forth. The environmental components 1160 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1162 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1150 may include communication components 1164 operable to couple the machine 1100 to a network 1180 or devices 1170 via a coupling 1182 and a coupling 1172, respectively. For example, the communication components 1164 may include a network interface component or another suitable device to interface with the network 1180. In further examples, the communication components 1164 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1170 may be another machine or any of a wide variety of peripheral devices (e.g., a peripheral device coupled via a USB).

Moreover, the communication components 1164 may detect identifiers or include components operable to detect identifiers. For example, the communication components 1164 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1164, such as location via Internet Protocol (IP) geolocation, location via Wi-Fi® signal triangulation, location via detecting an NFC beacon signal that may indicate a particular location, and so forth.

The various memories (i.e., 1130, 1132, 1134, and/or memory of the processor(s) 1110) and/or storage unit 1136 may store one or more sets of instructions and data structures (e.g., software) embodying or utilized by any one or more of the methodologies or functions described herein. These instructions (e.g., the instructions 1116), when executed by processor(s) 1110, cause various operations to implement the disclosed embodiments.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1180 may be an ad hoc network, an intranet, an extranet, a VPN, an LAN, a WLAN, a WAN, a WWAN, an MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1180 or a portion of the network 1180 may include a wireless or cellular network, and the coupling 1182 may be a Code Division Multiple Access (CDMA) connection, a Global System for Mobile communications (GSM) connection, or another type of cellular or wireless coupling. In this example, the coupling 1182 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UNITS), High Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 1116 may be transmitted or received over the network 1180 using a transmission medium via a network interface device (e.g., a network interface component included in the communication components 1164) and utilizing any one of a number of well-known transfer protocols (e.g., hypertext transfer protocol (HTTP)). Similarly, the instructions 1116 may be transmitted or received using a transmission medium via the coupling 1172 (e.g., a peer-to-peer coupling) to the devices 1170. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1116 for execution by the machine 1100, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A method comprising:
storing, by a network site, a plurality of listings from a plurality of different posting end-users;
receiving, from a searching end-user, a listing request for one or more of the listings posted to the network site, the listing request specifying a multiple-day length of stay parameter;
determining that the multiple-day length of stay parameter of the listing request transgresses a minimum length of stay threshold;
in response to determining that the multiple-day length of stay parameter of the listing request transgresses the minimum length of stay threshold, generating a combined listing comprising a first listing of the plurality of listings associated with a first portion of the multiple-day length of stay parameter and a second listing of the plurality of listings associated with a second portion of the multiple-day length of stay parameter; and
causing, on a user device of the searching end-user, presentation of the combined listing together with one or more other listings of the plurality of listings that match the listing request in a ranked order.

2. The method of claim 1, further comprising:
identifying a set of individual listings of the plurality of listings that match the listing request; and
determining that a quantity of listings in the set of individual listings fails to satisfy a minimum available inventory threshold, wherein the combined listing is generated in response to determining that the quantity of individual listings in the set of individual listings fails to satisfy a minimum available inventory threshold.

3. The method of claim 1, wherein the listing request comprises a destination category, further comprising:
determining that the first and second listings match the destination category, wherein the combined listing is generated in response to determining that the first and second listings match the destination category.

4. The method of claim 3, wherein the destination category comprises at least one of national parks, beaches, surfing, camping, theme parks, or skiing.

5. The method of claim 1, wherein the multiple-day length of stay parameter specifies a quantity of days or a flexible duration of stay, and wherein the minimum length of stay threshold comprises five days.

6. The method of claim 1, wherein generating the combined listing comprises:
identifying a subset of individual listings of the plurality of listings that satisfies one or more search criteria of the listing request independent of the multiple-day length of stay parameter;
for each individual listing in the subset, generating a plurality of groups of stays on which the individual listing is available, each group of stays being associated with availability of the individual listing during different portions of the multiple-day length of stay parameter;
refining the plurality of groups using an aggregator based on a user profile of the searching end-user;
determining that a first combination of the portion of availability of a first refined group of a first individual listing in the subset with the portion of availability of a second refined group of a second individual listing matches the multiple-day length of stay parameter; and
in response to determining that the first combination matches the multiple-day length of stay parameter, forming the combined listing based on the first refined group of the first individual listing and the second refined group of the second individual listing.

7. The method of claim 6, wherein each of the different portions comprises a set of days starting from a start date and ending prior to an end date, and wherein each of the different portions comprises a set of days starting from a date later than the start date and ending on the end date.

8. The method of claim 6, wherein a first group of the stays on which the individual listing is available comprises a first half of the multiple-day length of stay parameter, and wherein a second group of the stays on which the individual listing is available comprises a second half of the multiple-day length of stay parameter.

9. The method of claim 6, further comprising:
determining that a second combination of the portion of availability of the first refined group of the first individual listing with the portion of availability of a third refined group of a third individual listing matches the multiple-day length of stay parameter;
computing a rank for the first and second combinations; and
selecting either the first or second combination to generate the combined listing based on the computed rank of the first and second combinations.

10. The method of claim 9, wherein the rank for the first and second combinations is computed based on individual ranks of the first, second and third individual listings.

11. The method of claim 9, wherein computing the rank for the first and second combinations comprises:
computing a first difference between the portion of availability of the first refined group of the first individual listing and the portion of availability of the second refined group of the second individual listing;
computing a second difference between the portion of availability of the first refined group of the first individual listing and the portion of availability of the third refined group of the third individual listing; and
associating a first rank with the first combination that is greater than a second rank associated with the second combination in response to determining that the first difference is smaller than the second difference.

12. The method of claim 9, wherein computing the rank for the first and second combinations comprises:
computing a first compatibility criterion between the first individual listing and the second individual listing;
computing a second compatibility criterion between the first individual listing and the third individual listing; and
associating a first rank with the first combination that is greater than a second rank associated with the second combination in response to determining that the first compatibility criterion is associated with a higher level of compatibility than the second compatibility criterion.

13. The method of claim 12, wherein the first and second compatibility criteria represent at least one of: quantity of overlapping listing attributes, quantity of listing attributes that match the user profile, price, image qualities, or distances between locations.

14. The method of claim 6, further comprising:
determining that a given individual listing matches the listing request; and
excluding the given individual listing from being used as a basis to form one or more combined listings.

15. The method of claim 1, wherein the combined listing is a first combined listing, further comprising:
preventing presentation of a second combined listing in response to determining that the second combined listing includes the first listing that is also included in the first combined listing to introduce diversity in the presentation of the combined listing together with the one or more other listings.

16. The method of claim 1, further comprising:
determining whether the listing request comprises a destination category; and
modifying a level of flexibility in ranking and combining listings to form the combined listing based on determining whether the listing request comprises the destination category.

17. The method of claim 16, further comprising:
determining that the level of flexibility in ranking and combining corresponds to an inflexible threshold level; and
in response to determining that the level of flexibility in ranking and combining corresponds to the inflexible threshold level, increasing a level of diversity among the listings used to form the combined listing.

18. The method of claim 1, wherein the plurality of listings includes at least one of locations or experiences.

19. The method of claim 1, further comprising:
determining that a distance between the first and second listings falls within a threshold range comprising a minimum distance and a maximum distance, wherein the combined listing is generated using the first and second listings in response to the distance between the first and second listings being between the minimum distance and the maximum distance of the threshold range.

20. The method of claim 1, further comprising automatically selecting a destination category to base the generation of the combined listing based on past interactions the searching end-user had with the network site.

21. The method of claim 20, wherein the past interactions includes at least one of: filtering criteria, types of destinations searched for in a past threshold interval, price point of searched listings, or family status.

22. The method of claim 1, further comprising:
applying one or more neural networks to generate the combined listing, to generate the ranked order, to compare a first combined listing with a second combined listing, and to select whether to present a given listing as part of a given combined listing or as an individual listing in the presentation.

23. A system comprising:
one or more processors of a machine; and
a memory storing instruction that, when executed by the one or more processors, cause the machine to perform operations comprising:
storing, by a network site, a plurality of listings from a plurality of different posting end-users;
receiving, from a searching end-user, a listing request for one or more of the listings posted to the network site, the listing request specifying a multiple-day length of stay parameter;
determining that the multiple-day length of stay parameter of the listing request transgresses a minimum length of stay threshold;
in response to determining that the multiple-day length of stay parameter of the listing request transgresses the minimum length of stay threshold, generating a combined listing comprising a first listing of the plurality of listings associated with a first portion of the multiple-day length of stay parameter and a second listing of the plurality of listings associated with a second portion of the multiple-day length of stay parameter; and
causing, on a user device of the searching end-user, presentation of the combined listing together with one or more other listings of the plurality of listings that match the listing request in a ranked order.

24. A machine-readable storage device embodying instructions that, when executed by a machine, cause the machine to perform operations comprising:
storing, by a network site, a plurality of listings from a plurality of different posting end-users;
receiving, from a searching end-user, a listing request for one or more of the listings posted to the network site, the listing request specifying a multiple-day length of stay parameter;
determining that the multiple-day length of stay parameter of the listing request transgresses a minimum length of stay threshold;
in response to determining that the multiple-day length of stay parameter of the listing request transgresses the minimum length of stay threshold, generating a combined listing comprising a first listing of the plurality of listings associated with a first portion of the multiple-day length of stay parameter and a second listing of the plurality of listings associated with a second portion of the multiple-day length of stay parameter; and
causing, on a user device of the searching end-user, presentation of the combined listing together with one or more other listings of the plurality of listings that match the listing request in a ranked order.

25. A method comprising:
accessing a plurality of listings;
generating a plurality of signals for each listing in the plurality of listings;
obtaining external environment information for a location associated with each listing;
accessing a plurality of guidelines associated with a given category;
determining that a collection of data associated with a first listing of the plurality of listings corresponds to the plurality of guidelines associated with the given category, the collection of data comprising a first set of signals in the plurality of signals associated with the first listing and a first set of the external environment information of the location associated with the first listing;
computing a confidence score for the first listing matching the given category; and
associating the first listing with the given category based on the computed confidence score.

26. A method comprising:
accessing a plurality of categories;
computing a rank for each of the plurality of categories based on a specified location, the rank being computed based on a uniqueness value of each of the plurality of categories relative to the specified location;
identifying a slot associated with a theme in a graphical user interface;
identifying a subset of the plurality of categories corresponding to the theme associated with the slot;
selecting a given category of the subset of the plurality of categories based on the rank associated with the given category; and
presenting the given category in the slot of the graphical user interface.
